(19) United States
(12) Patent Application Publication
(10) Pub. No.: US 2025/0069519 A1
(43) Pub. Date: Feb. 27, 2025

(54) LINGUISTIC LEARNING USING AUTOMATICALLY CASCADED TEXT

(71) Applicant: Cascade Reading, Inc., Edina, MN (US)

(72) Inventors: Julie A. Van Dyke, New Haven, CT (US); Michael Gorman, Edina, MN (US); Mark Lacek, Minneapolis, MN (US)

(21) Appl. No.: 18/810,322

(22) Filed: Aug. 20, 2024

Related U.S. Application Data
(60) Provisional application No. 63/520,901, filed on Aug. 21, 2023.

(51) Int. Cl. G09B 17/00; G06F 16/34; G06F 40/106; G06F 40/109; G06F 40/114; G06F 40/169

(52) U.S. Cl. CPC G09B 17/003; G06F 16/345; G06F 40/106; G06F 40/109; G06F 40/114; G06F 40/169

(57) ABSTRACT

Systems and techniques for linguistic learning using automatically cascaded text are described herein. A data model is generated to identify linguistic relationships among respective words and word groups in a source text. The data model is augmented with linguistic properties associated with individual words in the source text. An arrangement of cascaded text is determined based on the linguistic relationships identified in the data model. The arrangement of cascaded text includes horizontal displacement and vertical displacement for the respective words and word groups. Display enhancements to the arrangement of cascaded text are determined wherein the display enhancements are based on user-selected options to show visual aids that identify the linguistic relationships among the respective words and word groups or linguistic properties associated with individual words. The arrangement of cascaded text and the display enhancements are output in a user interface.

### PRIORITY CLAIM

This application claims the benefit of priority to U.S. Provisional Patent Application No. 63/520,901, filed Aug. 21, 2023, and titled “LINGUISTIC LEARNING USING AUTOMATICALLY CASCADED TEXT”, which is incorporated herein by reference in its entirety.

### TECHNICAL FIELD

Embodiments described herein generally relate to machine automated text processing, driven by large-scale natural language processing (NLP) techniques derived from theoretical linguistics. More specifically, the current embodiments relate to instructing grammatical knowledge and reading fluency via a cascade format, providing methods for summarizing text via the cascade format, and delivering such instructions via alternative display technologies.

### BACKGROUND

Standard text formatting entails presenting language in blocks, with little formatting beyond basic punctuation and line breaks or indentation indicating paragraphs. Cascaded text formatting, in contrast, transforms conventional block-shaped text into cascading patterns for the purpose of helping readers identify grammatical structure and related content. A cascaded text format makes the syntax of a sentence visible, and helps readers identify these relationships within a sentence.

Building sentences through the process of embedding language units inside other units enables language to represent an infinite number of meanings. Accordingly, a cascaded-parsing pattern is intended to enable the reader, when looking at a particular phrase, to immediately perceive how it relates to the phrases that precede or follow it.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of principles for generating cascaded text, according to an embodiment.

FIG. 2 is a block diagram of an example of an environment and a system for linguistic learning using automatically cascaded text, according to an embodiment.

FIG. 3 illustrates an example of a Cascade Explorer user interface for linguistic learning using automatically cascaded text, according to an embodiment.

FIG. 4 illustrates an example of a part of speech labeling control activated to identify adjectives and nouns for a Cascade Explorer user interface for linguistic learning using automatically cascaded text, according to an embodiment.

FIG. 5 illustrates an example of a constituent labeling control activated to identify prepositional phrases for a Cascade Explorer user interface for linguistic learning using automatically cascaded text, according to an embodiment.

FIG. 6 illustrates an example of a constituent labeling control activated to identify direct objects for a Cascade Explorer user interface for linguistic learning using automatically cascaded text, according to an embodiment.

FIG. 7 illustrates an example of alignment, line, and sentence page controls for a Cascade Explorer user interface for linguistic learning using automatically cascaded text, according to an embodiment.

FIG. 8 illustrates an example of a highlighting control for a Cascade Explorer user interface for linguistic learning using automatically cascaded text, according to an embodiment.

FIG. 9 illustrates an example of a reading view for a Cascade Explorer user interface for linguistic learning using automatically cascaded text, according to an embodiment.

FIGS. 10A to 10F illustrate examples of parsing outputs used to generate a linguistic relationship model, according to an embodiment.

FIG. 11 illustrates a block diagram of an example of a dependency parse and cascaded text output for linguistic learning using automatically cascaded text, according to an embodiment.

FIGS. 12A to 12F illustrate example outputs and methods of collapsing a cascaded text output, according to an embodiment.

FIGS. 13A and 13B illustrate examples of colorization for linguistic learning using automatically cascaded text, according to an embodiment.

FIG. 14 illustrates a text portion segmented into a plurality of dependent segments based on a linguistic relationship model, according to an embodiment.

FIG. 15 illustrates a text portion displayed with a hierarchical position specified for each segment, according to an embodiment.

FIG. 16 illustrates an example of a method for building a linguistic relationship model for linguistic learning using automatically cascaded text, according to an embodiment.

FIG. 17 illustrates an example of a head-worn display for linguistic learning using automatically cascaded text, according to an embodiment.

FIG. 18 illustrates an example of a process for outputting content to a head-worn display for linguistic learning using automatically cascaded text, according to an embodiment.

FIG. 19 illustrates a flow diagram of an example of a process for selecting content and generating feedback for an input cascade for linguistic learning using automatically cascaded text, according to an embodiment.

FIG. 20 illustrates an example of an interactive user interface including input and formatting controls to receive a cascade input for linguistic learning using automatically cascaded text, according to an embodiment.

FIG. 21 illustrates an example of an interactive user interface including feedback controls to present feedback to a user based on a received cascade input for linguistic learning using automatically cascaded text, according to an embodiment.

FIG. 22 illustrates a flow diagram of an example of a process for generating cascaded text and a cascade-concept map for linguistic learning using automatically cascaded text, according to an embodiment.

FIG. 23 illustrates a flow diagram of an example of a process for selecting feedback content based on missed concepts and profile data for linguistic learning using automatically cascaded text, according to an embodiment.

FIG. 24 illustrates a flow diagram of an example of a method for linguistic learning using automatically cascaded text, according to an embodiment.

FIG. 25 is a block diagram illustrating an example of a machine upon which one or more embodiments may be implemented.

### DETAILED DESCRIPTION

The systems and methods discussed herein utilize linguistic analyses derived from linguistic theory to determine cascades. Such analyses are the state-of-the-art in automated natural language processing (NLP), allowing the systems and methods discussed herein to capitalize on inputs provided from NLP services (hereafter, NLP Services) and similar types of human language processing services and platforms. The systems and methods discussed herein use NLP Services (e.g., a constituency parser, a dependency parser, a co-reference parser, etc.) to parse incoming text into a linguistic relationship model that highlights linguistic relationships between constituents in the text. Display rules, including cascade rules, are then applied to the linguistic relationship model to make linguistic relationships more visible for the reader in an arrangement referred to herein as “cascaded text” or a “cascade.” The representations of cascaded text are then presented with various enhancements and functionality, to enable various learning and educational use cases for improving reading comprehension.

A linguistic constituent is a word, or group of words, which fills a particular function in a sentence. For example, in the sentence “John believed X”, X could be substituted by a single word (“Mary”) or (“facts”) or by a phrase (“the girl”) or (“the girls with curls”) or (“the girl who shouted loudly”) or by an entire clause (“the story was true.”). In this case, all of these are constituents that fill the role of the direct object of “John believed.” Notably, constituents have a property of completeness—“the story was” is not a constituent because it cannot stand alone as a grammatical unit. Similarly, “the girl who” or “the” is not a constituent. In addition, constituents may be embedded within other constituents. For example, the phrase “the girls with curls” is a constituent, but so is “the girls” and “with curls.” However, the phrase “girls with” is not a constituent because it cannot stand alone as a grammatical unit. Consequently, “girls with” cannot fill any grammatical function, whereas the constituent phrases “the girls” or “with curls” are both eligible to fill necessary grammatical functions in a sentence. A part of speech is a category of syntactic function (e.g., noun, verb, preposition, etc.) of a word. Unlike parts of speech that describe the function of a single word, constituency delineates sets of words that function as a unit to fill particular grammatical roles in the sentence (e.g., subject, direct object, etc.). Hence, it provides more information about how groups of words are related within the sentence.

The systems and methods discussed herein implement constituent cascading, in which constituents are displayed following a set of rules that determine various levels of indentation. In an example, rules are jointly based on information from a constituency parser and a dependency parser. The constituency parser can be implemented by an NLP Service that identifies constituents as just described using a theory of phrase structure (e.g., X-bar Theory). The dependency parser can be implemented by an NLP Service that provides labeled syntactic dependencies for each word in a sentence, describing the syntactic function held by that word (and the constituent comprising it). The set of syntactic dependencies is enumerated by the universal dependency initiative (UD, http://universaldependencies.org) which aims to provide a cross-linguistically consistent syntactic annotation standard. Apart from English, the syntactic analysis may support a variety of additional languages, by way of example and not limitation, including: Chinese (Simplified), Chinese (Traditional), French, German, Italian, Japanese, Korean, Portuguese, Russian, and Spanish.

Through implementing a process of text cascading, the systems and methods discussed herein provide visual cues to the underlying linguistic structure in texts. These cues serve a didactic function, and numerous embodiments are presented that exploit these cues to promote more accurate and efficient reading comprehension, greater ease in teaching grammatical structures, and tools for remediation of reading-related disabilities.

In an example, the cascade is formed using line breaks and indentations based on constituency and dependency data obtained from parsing operations. Cascade rules are applied such that prioritization is placed on constituents remaining complete on a line or indicated as a continuous unit in situations where device display limitations may prevent display on a single line. This promotes easy identification of which groups of words serve together in a linguistic function, so that constituents can be identified more easily. Accurate language comprehension requires the ability to identify relationships between the entities or concepts presented in the text. The cascade rules may include rules to align a subject with predicates, indent grammatical dependencies, group conjoined items, and indent introductory phrases. In an example, the dependency data may be obtained and the constituents may be identified using the dependency data. In an example, the dependency data and the constituency data may be generated through a machine learning process, obtained as metadata of the text, etc. In an example, the constituency data may be generated from the dependency data or the dependency data may be generated from the constituency data resulting in either the dependency data or the constituency data being obtained and the other being generated form the obtained data.

A prerequisite to this is the ability to parse out constituents (i.e., units of text that serve a discrete grammatical function). Evidence suggests that poor comprehenders have substantial difficulties identifying syntactic boundaries that define constituents during both reading and oral production (e.g., Breen et al., 2006; Miller and Schwanenflugel, 2008). Moreover, boundary recognition is especially important for complex syntactic constructions of the sort found in expository texts (i.e., textbooks, newspapers, etc.). These facts suggest that the ability to identify syntactic boundaries in texts is especially important for reading comprehension, and that methods of cuing these boundaries may serve as an important aid for struggling readers. However, standard text presentation methods (i.e., presenting texts in left-justified blocks) do not explicitly identify linguistic constituents, or provide any means to support the process of doing so. The systems and methods discussed herein present a means of assessing an ability of a user to explicitly cue syntactic boundaries and dependency relationships using visual cues such as line-breaks (e.g., carriage return, line feed, etc.), indentations, highlighting in color, italics, underlining, etc.

In an example, the user may be presented with a variety of interactive user interfaces that provide educational content to teach the user to recognize linguistic components of text passages. The interactive user interfaces may support educational exercises that include drag-and-drop exercises, fill-in-the-blank exercises, multiple-choice exercises, select and de-select exercises, etc. In an example, the text passage may be automatically cascaded by applying the cascade rules to the passage using a linguistic relationship model that includes words and other linguistic elements of the passage with corresponding tags, metadata, or another linguistic labeling mechanism.

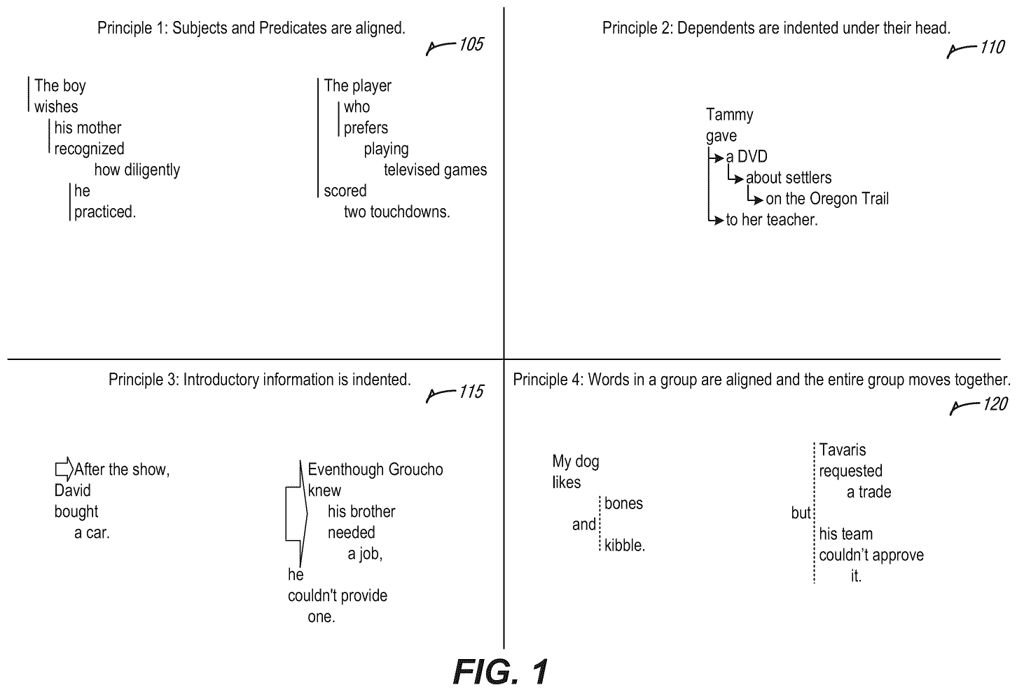

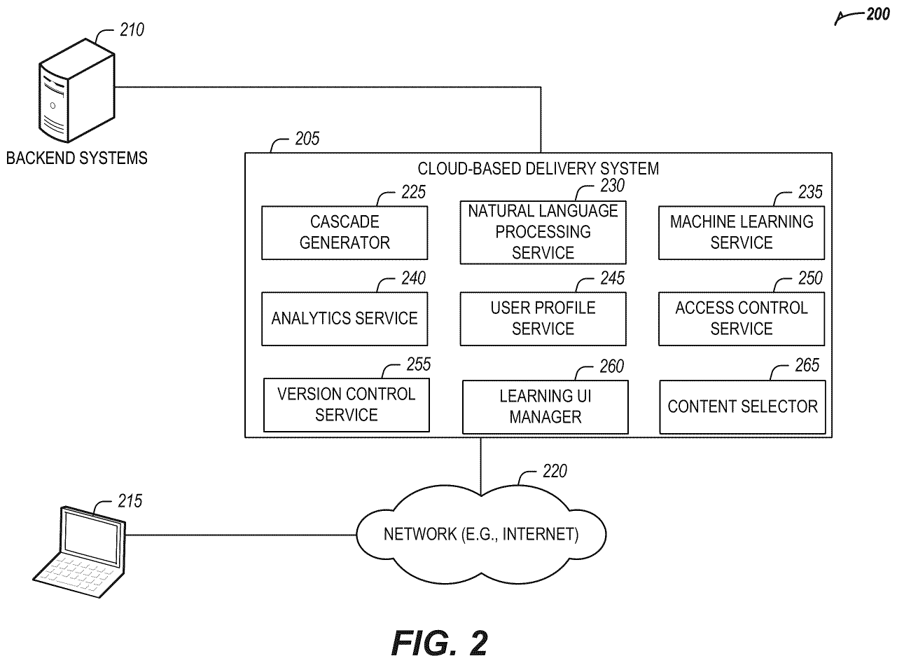

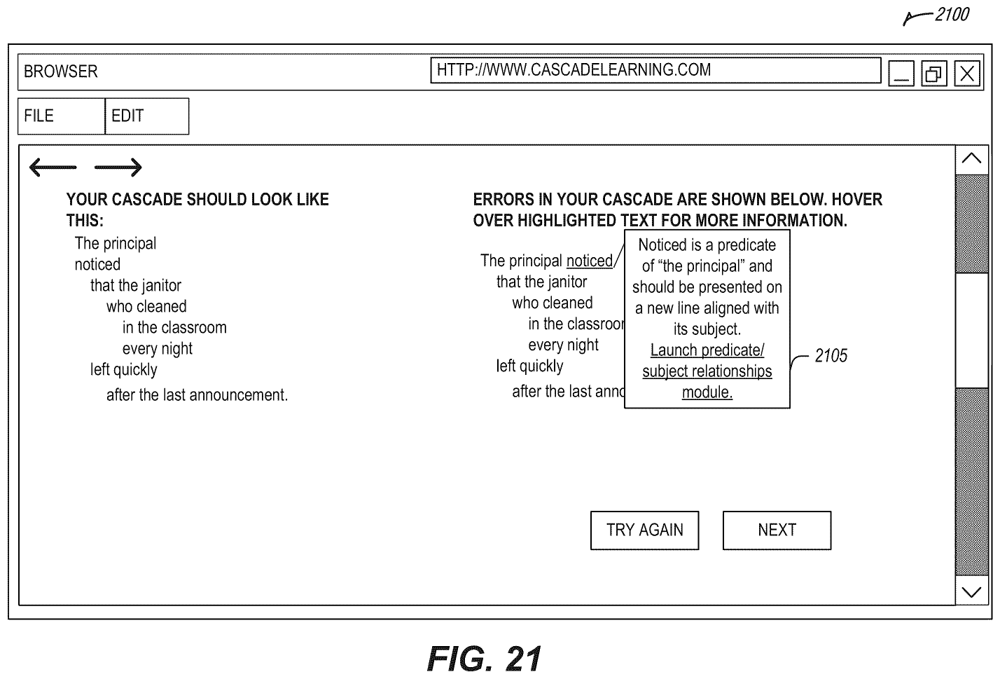

FIG. 1 illustrates four principles 105, 110, 115, and 120 that determine a shape of a cascade. The four principles are comprised of a first principle 105 that aligns subjects and predicates, a second principle 110 that indents dependents under their head, a third principle 115 that indents introductory information, and a fourth principle 120 that aligns words in a group and moves the entire group together. In an example, the user may be presented with a text passage and a text input control device with formatting tools that are used to transform the passage into a cascade format according to previously learned knowledge of four principles that determine the shape of a cascade. The user output is then compared to the passage that is parsed and cascaded automatically by the cascade rules (e.g., as applied by the cascade generator 225 as described in FIG. 2, etc.). The input provided by the user is then compared to the machine cascaded passage, and the comparison identifies points where the user cascade violates the four principles. These violations coincide with errors in the understanding of the syntax of the sentence by the user, and may be the basis for additional instruction within or outside of the interface. In an example, the comparison of user input to a correct cascade that is algorithm generated provides information to drive further interactions with the user. These “mismatches” may serve as a basis for a tutoring program that teaches the user syntactic knowledge or comprehension skills via the cascade (e.g., as illustrated in FIG. 21).

In an example, the mapping of rules to linguistic elements and relationships may be used to identify user interface sequences to be displayed (e.g., as shown in element 2105 of FIG. 21) to the user. These sequences can provide additional learning exercises to the user to reinforce linguistic elements and demonstrate relationships mapped to the violated cascade rules. In another example, the machine-cascaded passage may be output for display in the user interface to provide feedback to the user. In an example, the user interface may be converted to a split screen with the input cascaded passage displayed in a first screen and the machine cascaded passage displayed in a second screen. In an example, the errors may be displayed with highlighting, underlining, or other formatting to draw the attention of the user to the mistakes. In an example, the erroneous portions of the input cascade may be converted to hyperlinks, pop-up controls, hover controls, etc. that, when activated by the user, provide an explanation of the error, information for correcting the error, controls or links to activate a learning module specific to the error, etc. The user cascade is compared to a correct cascade as produced by the algorithm and the mismatch is used for instruction.

The systems and techniques discussed herein may include a variety of interactive learning functions to display a text selected from a corpus of passages, and may be organized by difficulty level, expected learning outcome, etc. A profile may be maintained for the user that indicates a learning level (e.g., school grade level, comprehension level, proficiency level, learning progress level, etc.) of the user. The learning level may be used during selection of the interactive learning functions and the text to be displayed. In an example, the learning level may be used to select a user interface template (e.g., look and feel, etc.) of the interactive learning functions and may be used to select appropriate feedback to present to the user. For example, a user who is an adult may receive more text-based prompts and feedback while a user who is a second-grade school child may receive more graphical (e.g., pictures, icons, etc.) or auditory (e.g., pronunciations, recordings of sentences or paragraphs with correct intonation and phrasing, etc.) prompts and feedback while proceeding through the learning functions.

FIG. 2 is a block diagram of an example of an environment 200 and a system 205 for linguistic learning using automatically cascaded text, according to an embodiment. The environment 200 may include the system 205 which may be a cloud-based delivery system (or other computing platform (e.g., a virtualized computing infrastructure, software-as-a-service (SaaS), internet of things (IoT) network, etc.)). The system may be distributed amongst a variety of backend systems 210 that provide infrastructure services such as computing capacity and storage capacity for a cloud services provider hosting the system 205. The system 205 may be communicatively coupled (e.g., via wired network, wireless network, cellular network, shared bus, etc.) to a network 220 (e.g., the internet, private network, public network, etc.). An end-user computing device 215 may be communicatively connected to the network and may establish a connection to the system 205. The end-user device may communicate with the system 205 via a web-browser, downloaded application, on-demand application, etc. In an example, components of the system may be prepared for delivery to the end-user computing device 215 via an installed application providing offline access to features of the system 205.

The system 205 may use a direct online connection, via the end-user computing device 215, to distribute a set of packaged services to end-user application on the end-user computing device 215 that operates offline without internet connectivity, or that operates as a hybrid with an end-user application that connects (e.g., via a plug-in, browser extension, scripting or script functions, etc.) to the cloud service (or other computing platform) over the internet. A hybrid mode enables the user to read in cascade format regardless of connectivity, but still provides data to improve the system 205.

The end-user application may be deployed in a number of forms. For example, a browser plug-in and extensions may enable users to change the formatting of the text they read on the web and in applications into the cascading format. In another example, the end-user application may be integrated into a menu bar, clip board, browser extension or plug-in, or text editor so that when a user highlights text using a mouse or hotkeys (or invokes an equivalent touch-screen gesture), a window or overlay may be presented with selected text rendered using the cascade format. In another example, the end-user application may be a portable document file (PDF) or electronic book (eBook) reader that may input a structured file (e.g., PDF file) as an input source and may output the cascade format for display to the user. In another example, the end-user application may be an augmented image enhancement that translates a live view from a camera and may apply optical character recognition (OCR) to convert the image to text and render the layout in cascade format in real time. In another example, the end-user application may be provided as a client-side or server-side extension to a chatbot or agent that provides generative text or content, to translate generative text into cascades as the generative text is provided to a human user at a browser, app, or other text viewer. This may include use of a large language model (LLM) or other generative artificial intelligence technique used to compile and return data in human readable form. In yet another example, the end-user application may be provided as an extension to an augmented reality (AR), virtual reality (VR), or mixed reality (MR) user interface or interactive control. The version control service 255 may track application versions and may provide periodic updates to the portable components provided to the application executing on the end-user computing device 215 when connected to the Internet.

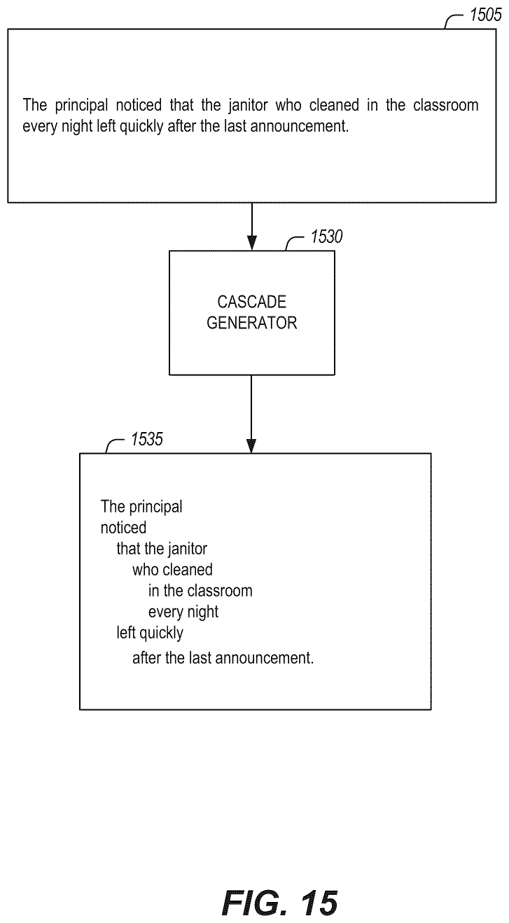

According to an example embodiment, end-user computing device 215 includes OCR capabilities that enables the user to capture an image of text via camera (e.g., on their phone, etc.) and have the text instantly converted into the cascade formatted text (e.g., as shown in FIG. 15). According to an embodiment, the end-user computing device 215 includes or is mounted in a user-worn device such as smart glasses, smart contact lenses, a standalone or tethered headset, and the like, where input of text seen or to be seen by the user is converted into cascaded format for enhanced comprehension. In this way the text may be converted in real-time by the user's personal viewing device. According to another example embodiment, end-user computing device 215 provides augmented video, or other AR and VR applications of the cascade formatting within user interfaces of user-worn visual display devices, including AV and VR and similar mixed-reality headsets, glasses, and contact or implantable lenses that allow the user to see text in the cascade format.

The systems and methods discussed herein are applicable to a variety of environments where text is rendered on a device by processing the text and converting the text to cascade formatting. Display of text on a screen requires instructions on rendering and the cascade instruction set may be inserted in the command sequence. This may apply to a document type (e.g., PDF, etc.) and to systems with a rendering engine embedded where the call to the rendering engine may be intercepted and the cascaded formatting instructions inserted. In an example, a user may scan a barcode, a quick response (QR) code, or other mechanism for providing access to content (e.g., on a menu, product label, etc.) and the content may be returned in cascaded format.

The system 205 may include a variety of service components that may be executing in whole or in part on various computing devices of the backend systems 210 including a cascade generator 225, a natural language processing (NLP) service 230, a machine learning service 235, an analytics service 240, a user profile service 245, an access control service 250, and a version control service 255. The cascade generator 225, the NLP service 230, the machine learning service 235, the analytics service 240, the user profile service 245, the access control service 250, and the version control service 255 may include instructions including application programming interface (API) instructions that may provide data input and output from and to external systems and amongst the other services.

The system 205 may operate in a variety of modes: an end-user (e.g., reader, etc.) converts text at a local client using a local client instance that has a copy of offline components (such as a trained language processing model, presentation rules or algorithm implementations, dynamic scripting, executable binaries or libraries, etc.) for generating cascaded text; the end-user may send text to the system 205 to convert standard text to cascaded text; a publisher may send text to the system 205 to convert text to cascaded format; the publisher may use an offline component set of the system 205 to convert its text to cascade format; or the publisher may publish text in traditional block formatting or cascaded formatting using the system 205.

The cascade generator 225 may receive text input and may pass the text to the NLP service 230 parser to generate linguistic data. The linguistic data may include, by way of example and not limitation, parts of speech, word lemmas, a constituent parse tree, a chart of discrete constituents, a list of named entities, a dependency graph, list of dependency relations, linked coreference table, linked topic list, list of named entities, output of sentiment analysis, semantic role labels, entailment-referenced confidence statistics. Hence, for a given text, linguistic analysis may return a breakdown of words with a rich set of linguistic information for each token. This information may include a list of relationships between words or constituents that occur in separate sentences or in separate paragraphs.

The cascade generator 225 may apply cascade formatting rules and algorithms to a linguistic relationship model generated by the machine learning service 235 created using constituency data and dependency data to generate probabilistic cascade output. In various examples, the machine learning service 235 may implement one or more machine learning models or neural network models, including features of generative artificial intelligence (AI) that generates a cascade arrangement or cascade formatting rules based on training. Specific examples of neural network models may include large language models (LLMs) that include transformers to produce an output of text and metadata based on predictions or inferences. Further examples of cascade formatting rules, algorithms, and linguistic relationship models applicable to generate a cascade are provided in U.S. patent application Ser. No. 17/233,339 to Van Dyke et al., published as U.S. Pat. No. 11,170,154, which is incorporated by reference herein in its entirety.

The learning user interface (UI) manager 260 may generate a series of interactive learning user interfaces to be presented to the end-user computing device 215. The content selector 265 may select content and learning paths to be presented by the learning UI manager 260 based on data provided by the user profile service 245 such as learning level, success/failure of previous learning modules, etc. The learning paths may include a series of interactive interfaces that may include a variety of controls including drag-and-drop, fill-in-the-blank, multiple choice, free selection, etc. that may be presented to the user in conjunction with reference text passages. The user may be asked to complete activities using the controls to proceed through a learning path. The activities and reference text may be selected by the content selector 265 based on the learning level of the user and historical performance of the user in completing activities. The selected reference text may include a linguistic relationship model generated from parsing and NLP operations and may be output in cascade format based on output of the cascade generator.

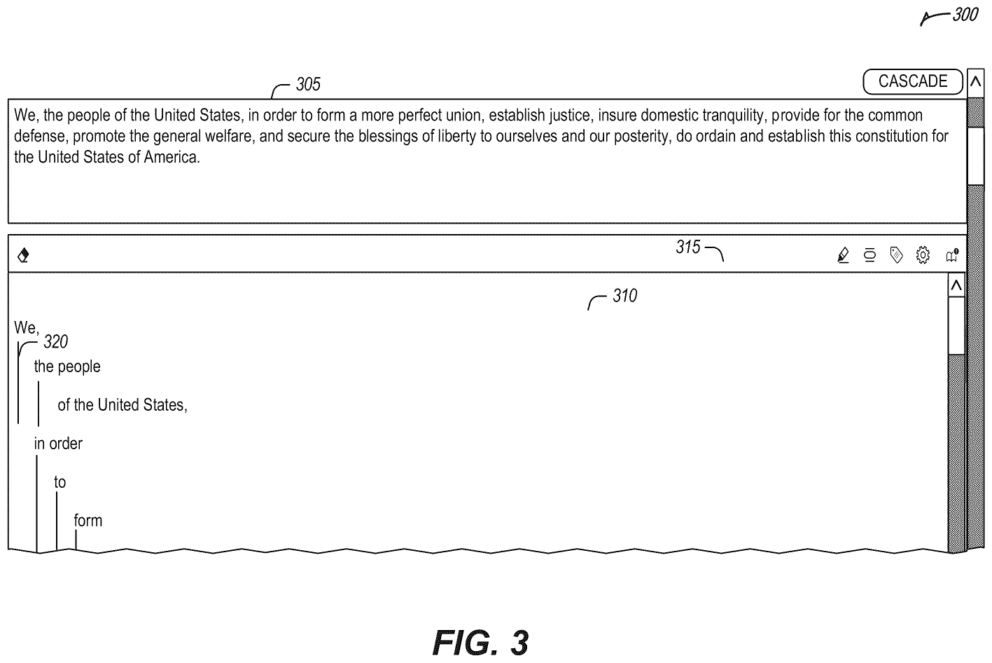

FIGS. 3 to 9 illustrate tools provided in a cascade explorer UI generated by the learning UI manager 260. In the following examples, a series of graphical UIs for presentation of the cascaded text (e.g., in a browser or other wide-screen app) is depicted. The UI controls described in FIGS. 3 to 9 modify or personalize the output of the cascaded text by evaluating user preference data and metadata from a linguistic relationship model used during cascade generation operations to determine enhancements to be displayed in conjunction with the cascaded text output. It will be understood, however, that other types of screens and layouts may be used to receive cascade exploration commands and perform actions on the cascaded text.

FIG. 3 illustrates an example of a cascade explorer user interface 300 for linguistic learning using automatically cascaded text, according to an embodiment. Here, the user interface includes a first section 305 providing a blockquote of text before cascading, and a second section 310 providing a portion of the text after cascading. The user interface also includes a navigation bar 315 to toggle display options such as highlighting, syntactic relationship identification, constituent-type, part of speech identification, summarization, and the like. These identifications occur via direct queries to the linguistic relationship model. Other selectable display options such as user preferences, settings, and respective reading modes may also be toggled in the navigation bar of the user interface.

In FIG. 3, the second section 310 presents visual cues to assist with the reading of the cascaded text. These visual cues include upright (vertical) bars or alignment lines 320 that depict the amount of horizontal indentation, consistent vertical spacing that separates respective lines of the cascade, and the alignment of text based on the dependency (with horizontal displacement such as tabs or horizontal spaces) and constituent (with vertical displacement such as line breaks or vertical spaces). Other examples of visual cues may include highlighting, formatting (e.g., bolding, emphasis, italics, font face changes), nesting or branching, animations, and the like.

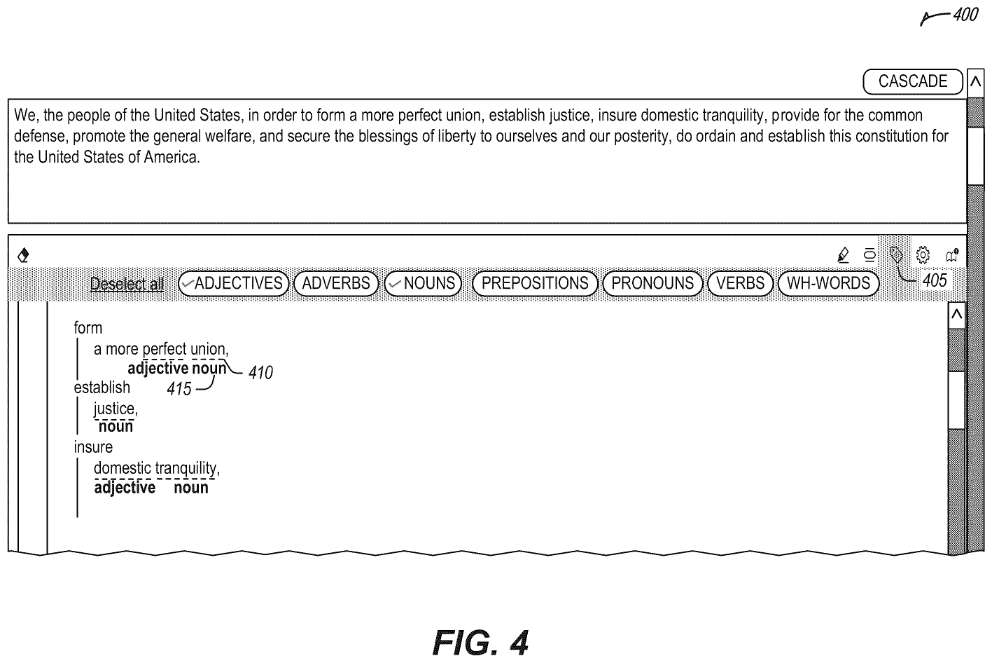

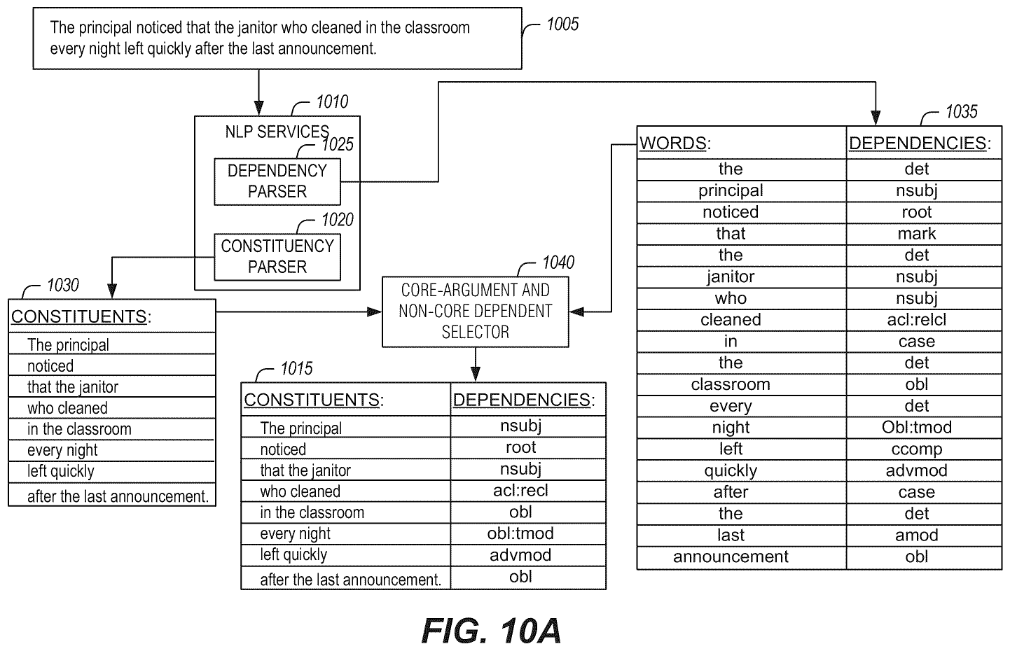

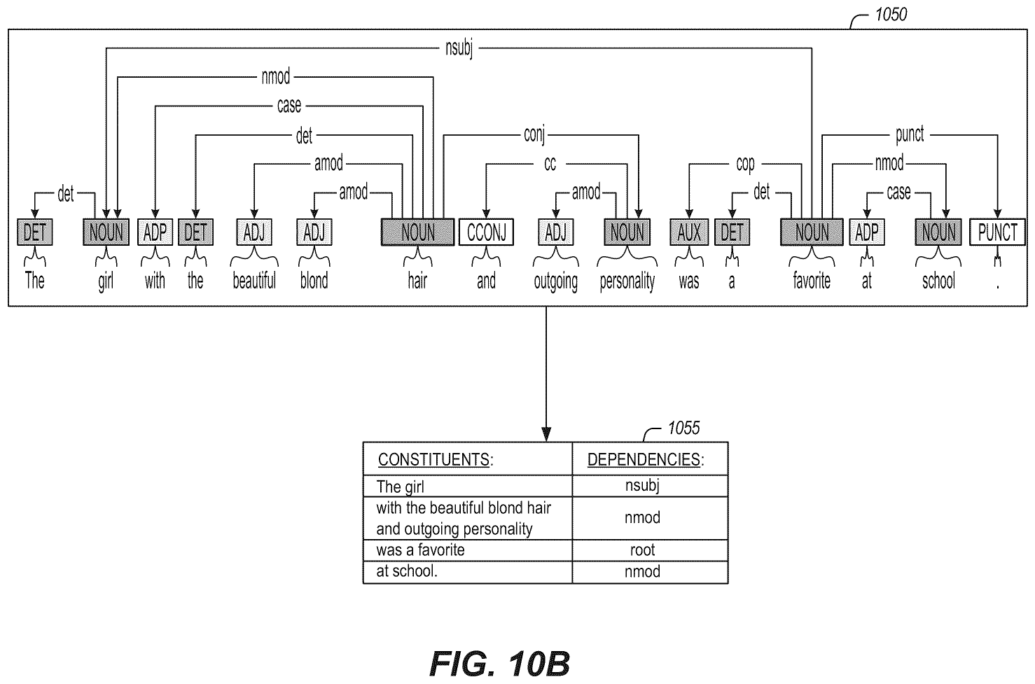

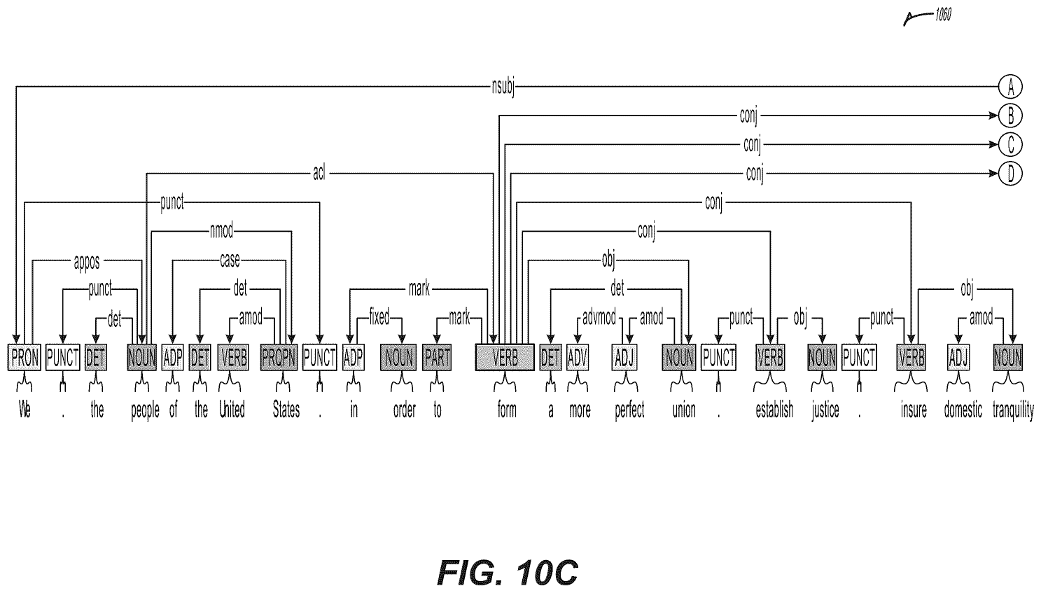

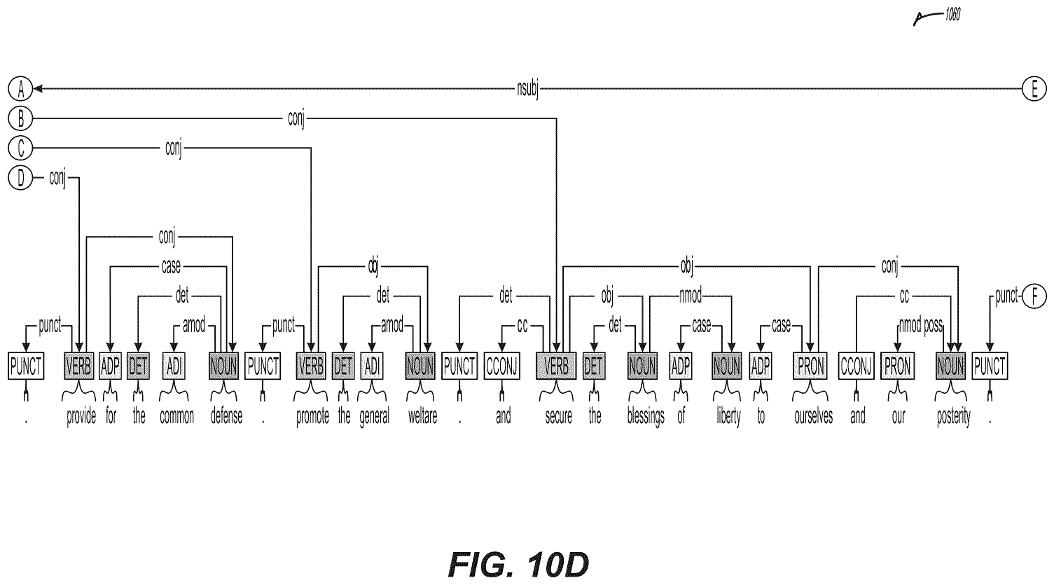

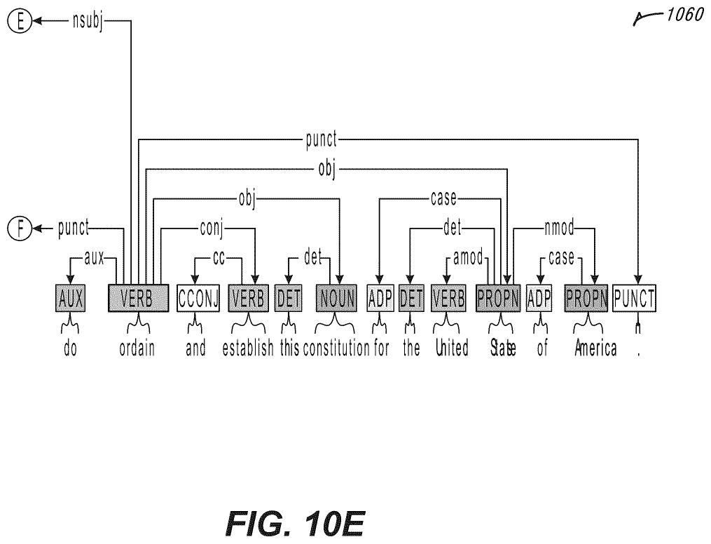

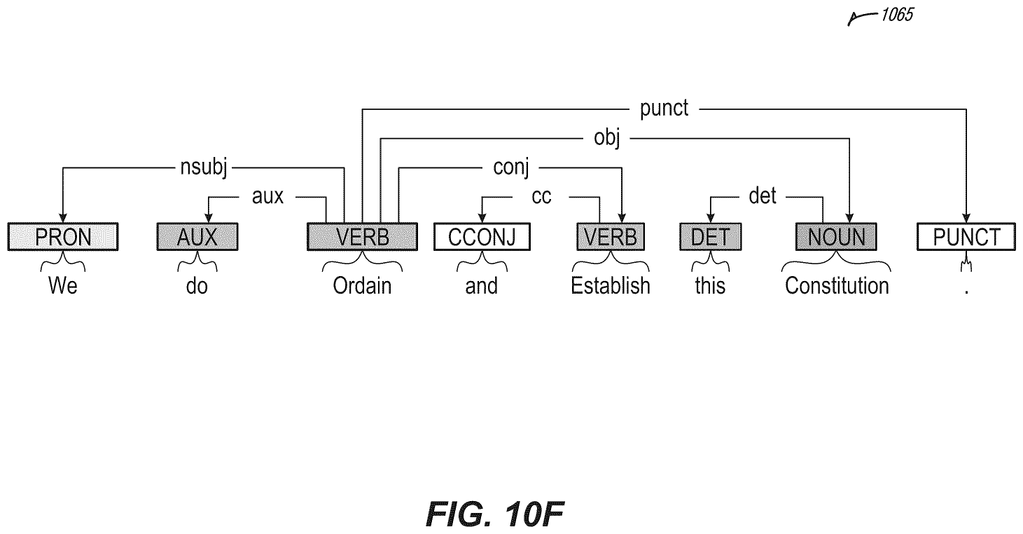

The exploration options in the Cascade Explorer user interface 300 may include user-selectable buttons that turn labels on or off, with the use of labels that identify particular parts of speech or constituent-types and dependency-relations (or both) in corresponding cascaded text, all of which are represented in a linguistic relationship model (e.g., the linguistic relationship model 1015 as described in FIG. 10A, etc.) used by the cascade generator 225 computed from constituency and dependency information (e.g., the dependency information in the dependency table 1035 as described in FIG. 10A, etc.). A part of speech for a particular word constitutes a categorization of the word in accordance with its syntactic function. The parts of speech identified in the cascade explorer interface 300 include noun, pronoun, determiner, adjective, adverb, preposition, verb, conjunction, quantifier, wh-word, or derivatives thereof. A constituent type for a particular word or word group refers to an X-bar constituent, which includes the head word and all modifying elements of that head (e.g., prepositional phrases, adjective phrases, noun phrases, verb phrases, adverbial phrases, etc.). The constituent types identified by the Cascade Explorer user interface 300 include but are not limited to noun phrases, adjective phrases, prepositional phrases, verb phrases, and any other phrase whose character is determined by the part of speech of the head of that phrase. The parts of speech that identified by the cascade explorer user interface 300 include but are not limited to adjectives, adverbs, nouns, prepositions, pronouns, verbs, predicates, prepositional phrases, and wh-words (i.e., words used to introduce questions and relative clauses) (e.g., as shown in FIG. 4).

The dependency relations identified by the Cascade Explorer user interface are defined by the Universal Dependencies set (universaldependencies.org). These include, but are not limited to, the most common ones such as subject, predicate, direct object, indirect object, interjection, noun modifier, etc.

FIG. 4 illustrates an example of a part of speech labeling control 405 activated to identify adjectives and nouns for a Cascade Explorer user interface 400 for linguistic learning using automatically cascaded text, according to an embodiment. As shown, multiple parts of speech (adjectives, nouns) are selected, and are accompanied by dashed lines 410 and text labels 415. Parts of speech are derived from the constituency and/or dependency parsers that populate the linguistic relationship model. In the view of cascaded text in FIG. 4, the dashed lines 410 and text labels 415 are shown immediately below a word or word group to identify selected parts of speech (nouns and adjectives), whereas these markings are not shown for unselected parts of speech (adverbs, prepositions, pronouns, verbs, wh-words).

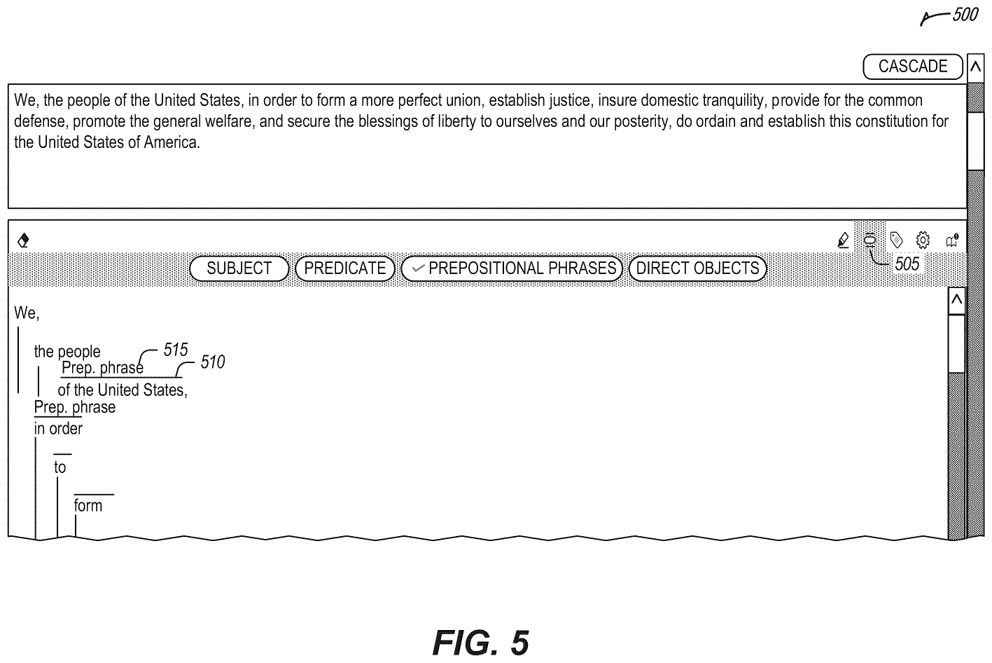

FIG. 5 illustrates an example of constituent labeling control 505 activated to identify prepositional phrases for a Cascade Explorer user interface 500 for linguistic learning using automatically cascaded text, according to an embodiment. Here, the user interface is modified to present exploration options, with a selection of prepositional phrases, and a de-selection of other syntax groups. Thus, in the view of cascaded text in FIG. 5, solid lines 510 and text labels 515 are shown immediately above a word or word group to identify prepositional phrases, whereas these markings are not provided to identify subjects, predicates, and direct objects. Prepositional phrases (or other selected syntax groups) are identified by referring to a linguistic relationship model (e.g., the linguistic relationship model 1015 as described in FIG. 10A, etc.), which identifies constituents based on output of the constituency parser. The labels may be accompanied by different text types or formatting than the cascaded text (e.g., smaller, and in another color) to not distract the reader from the understanding of the cascaded text. The labels may be placed in other positions or areas of the user interface.

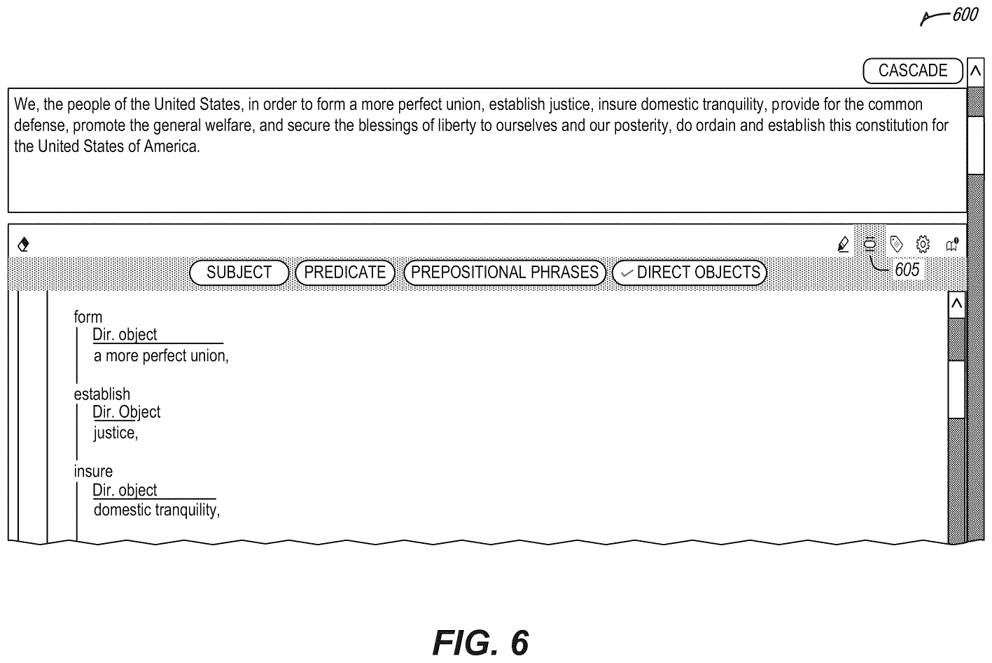

FIG. 6 illustrates an example of a dependency relation labeling control 605 activated to identify direct objects for a Cascade Explorer user interface 600 for linguistic learning using automatically cascaded text, according to an embodiment. Here, the user interface presents exploration options with a selection of direct objects, and a de-selection of other syntax groups. In some examples, only one syntax group can be labeled at a time; in other examples, multiple syntax groups can be labeled at a time. In still other examples, if particular syntax groups are not applicable to the cascaded text (e.g., a lack of prepositional phrases), then the user interface button or similar control may be “grayed out” or disabled for use (e.g., to disable use of the “prepositional phrases” button). Syntax groups are identified based on the information in a linguistic relationship model (e.g., the linguistic relationship model 1015 as depicted in FIG. 10A, etc.).

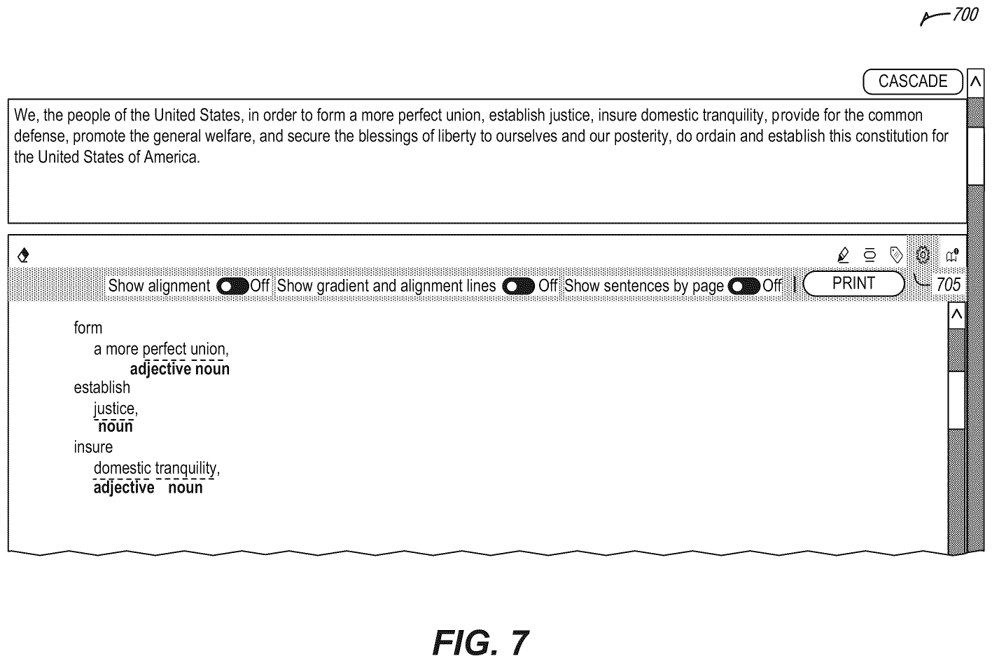

FIG. 7 illustrates an example of alignment, line and sentence settings, provided in page controls 705 for a Cascade Explorer user interface 700 for linguistic learning using automatically cascaded text, according to an embodiment. The page controls 705 depicted in FIG. 7 can be used to activate functions that toggle or modify the display of alignment cues, or to change the display of gradients or specific types of alignment lines (e.g., such as alignment lines 320 as shown in FIG. 3, etc.) that highlight the alignment cues. Additionally, the selection of “Show sentences by page” allows respective sentences to be separated with pagination. This enables sentences to be individually presented on a single screen, allowing a portrayal similar to turning a page to present and view each sentence in a cascade. This may be used in instruction contexts, where an instructor may want to focus on individual sentences. Other page controls may be provided to toggle or adjust the presentation of visual cues and formatting settings.

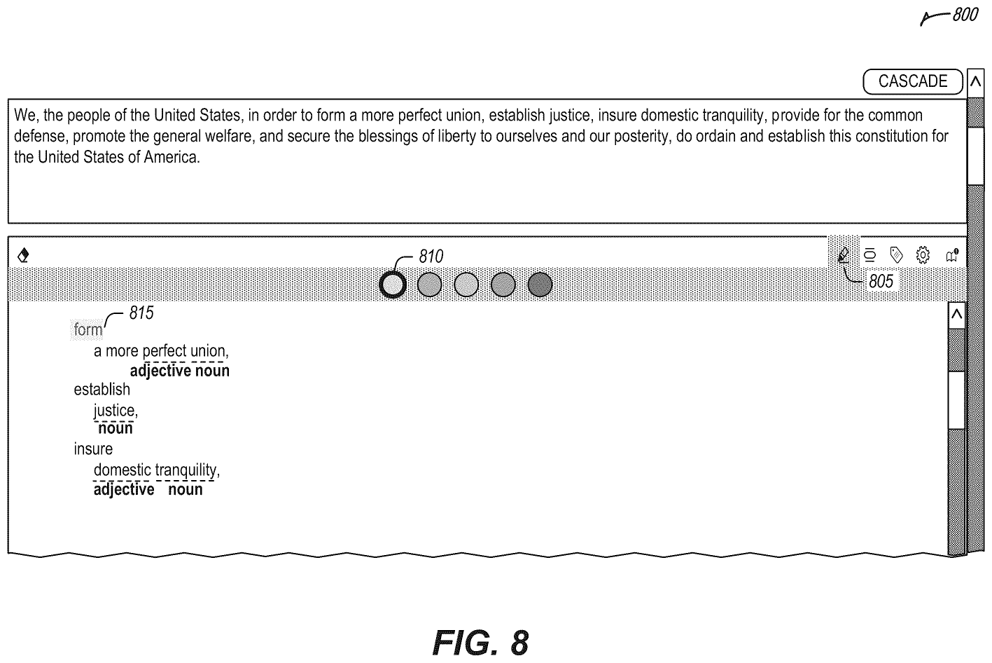

FIG. 8 illustrates an example of a highlighting control 805 for a Cascade Explorer user interface 800 for linguistic learning using automatically cascaded text, according to an embodiment. Here, multiple highlighting options can be presented. The selection of a particular highlighting option, such as corresponding to a yellow highlight 810, can be activated and followed by the selection of individual words or word groups 815. Each highlighting option may be associated with a particular color (e.g., yellow, orange, pink, violet, green, etc.) and text formatting option (e.g., italics, bold, etc.). The highlighting may include particular levels of transparency or opacity to ensure visibility of the highlighting and readability of the underlying word. The highlighting functionality may be used by an instructor (or reader) to select and mark particular words or word groups 815 that are not understood by the reader, or to bookmark or save the particular words or word groups 815.

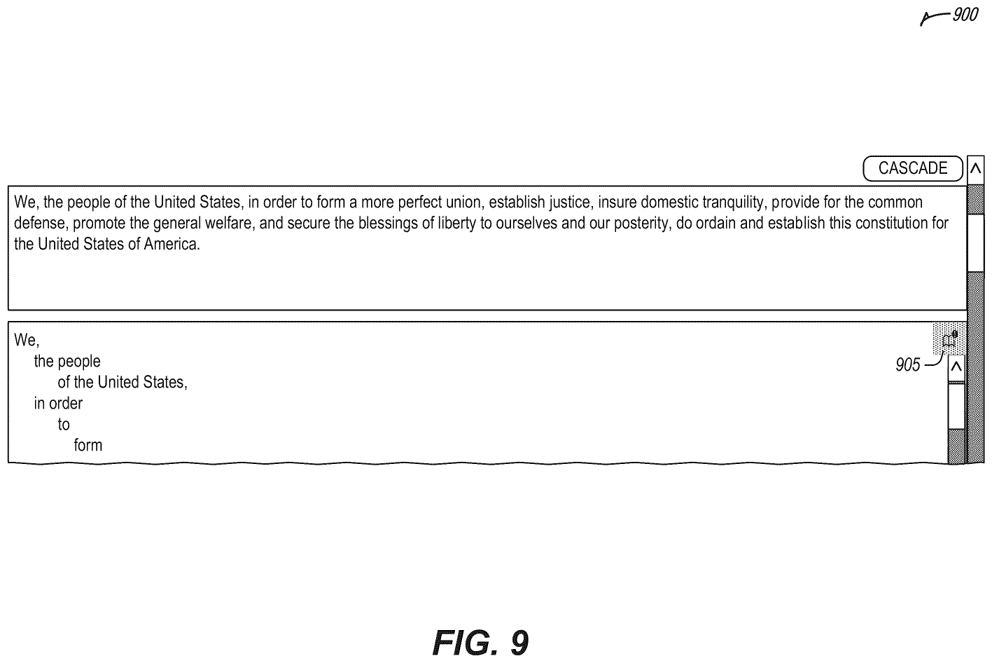

FIG. 9 illustrates an example of a reading view 905 for a cascade explorer user interface 900 for linguistic learning using automatically cascaded text, according to an embodiment. Here, the reading view presents a clean view of the cascade without display modification options. In some examples, the reading view may be associated with specific display settings or previously set preferences for a particular user, such as automatic formatting, pagination, and movement (e.g., to present different sections and enhancements to the cascaded text using a setting based on the user's reading level).

In any of the exploration or reading user interfaces depicted in FIGS. 3 to 9, additional functionality may be provided to assist a reader to read multiple sections of a cascade. This may include the use of automatic scrolling, user-controlled scrolling, or user-adaptive scrolling, or similar approaches for presenting different sections of the cascade text over time. One example of user-adaptive scrolling may be provided by user feedback delivered from eye tracking, to scroll or reposition a cascade text segment based on the speed of movement of the user's eye during reading. Another example of automatic scrolling may be based on an estimated or defined reading rate, which automatically scrolls or repositions a cascade text segment over time. Related functions may include indicators to show the amount of text remaining for reading, the position of a currently presented cascade in a larger corpus of text, or other progress indicators that correspond to time, position, or educational tasks.

Any of the previous user interfaces may provide an output of cascaded text based on linguistic information such as constituencies and dependencies established in a linguistic relationship model.

FIG. 10A illustrates an example of creation of a linguistic relationship model 1015, according to an embodiment. As illustrated in FIG. 10A, a text portion 1005 is segmented into a plurality of dependent segments based on grammatical information determined from the text portion 1005 based on output from the NLP services 1010. Each of these are a complete constituent, as defined by the constituency parser 1020 and output in a constituent table 1030, and have a dependency role as determined by the dependency parser 1025, as output in a dependency table 1035, associated with the head of the constituent. In one embodiment, constituents are identified by their maximal projection (XP) and assigned to the dependency relation associated with the head of that projection (X). For example, the constituent ‘the principal’ has two dependencies associated with it (det and nsubj), but the full NP constituent is assigned as an nsubj for interpretation by the cascade generator. A core-argument and non-core-dependent selector 1040 fuses the constituency and dependency data and adds metadata to the fused constituent data and dependency data to generate the linguistic relationship model 1015.

The shape of a cascade depends on analyses of both the constituency parser 1020 and the dependency parser 1025, which are integrated within the linguistic relationship model 1015. The linguistic relationship model 1015 describes the full linguistic content of a sentence, which is translated into the cascade format via a cascade generator (e.g., the cascade generator 225 as described in FIG. 2, etc.). This relationship model includes other metadata derived from the NLP Services, including parts of speech, linguistic relationship, etc.—any of which may be made visible via Cascade Explorer buttons (e.g., in FIGS. 4-6).

The cascade generator interacts with the linguistic relationship model to enable displays to be modified so as to present a simplified cascade based on user preferences. Cascades may be simplified by collapsing non-core dependents, so that the primary (core) relationships in the sentence are maintained. This amounts to collapsing all “optional” modifying elements in a sentence, including subordinate clauses, prepositional, adjectival, adverbial, and other modifying types of phrases.

Simplified cascades that retain the basic meaning of the sentence are useful for summarizing content, or highlighting optional or required components of the sentence. FIG. 10B illustrates an example of a sentence with multiple non-core or modifying phrases that may be reduced into only the simple subject and predicate. For example, in a sentence “The girl with the beautiful blonde hair and outgoing personality was a favorite at school,” a prepositional phrase “with the beautiful blond hair and outgoing personality” is a noun modifier (nmod) for ‘girl’ and the prepositional phrase “at school” is a denoted in a language relationship model 1055 as noun modifier (nmod) for ‘favorite’ (e.g., as determined in part by the dependency parse output 1050 output as shown in FIG. 10B). To simplify the sentence, these nmod phrases could be removed so that the basic sentence ‘the girl was a favorite’ is presented.

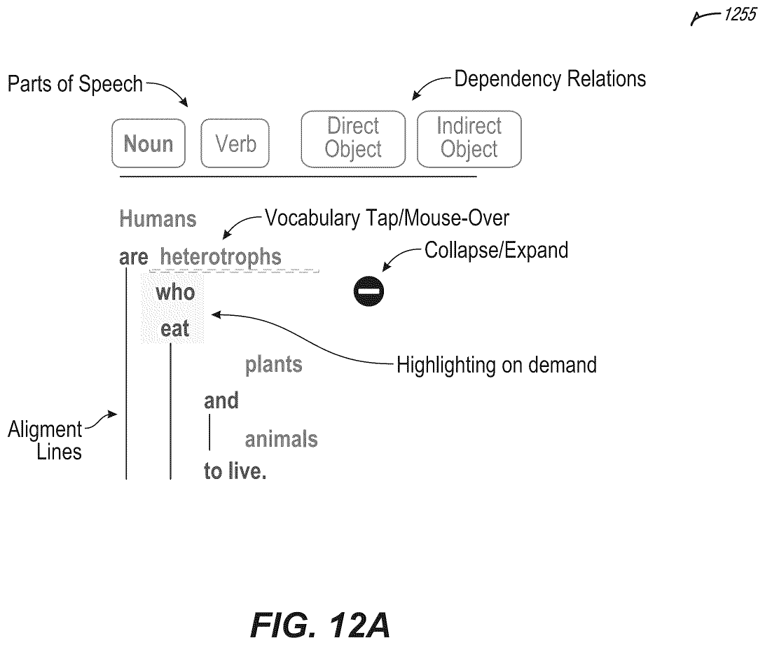

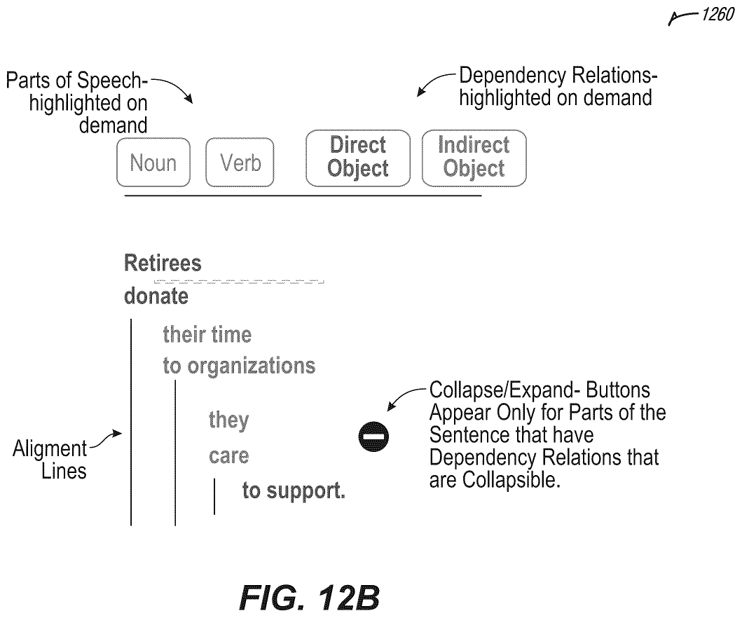

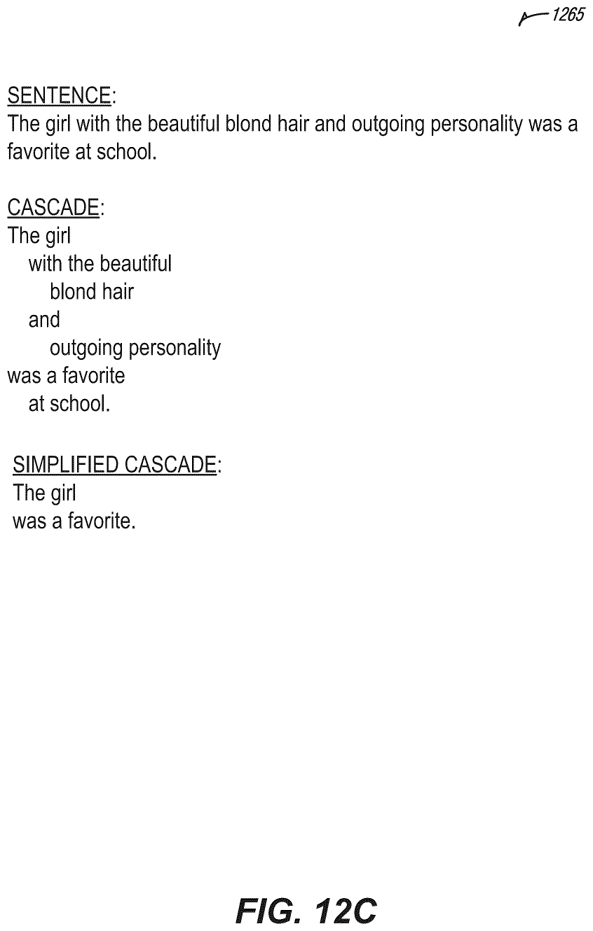

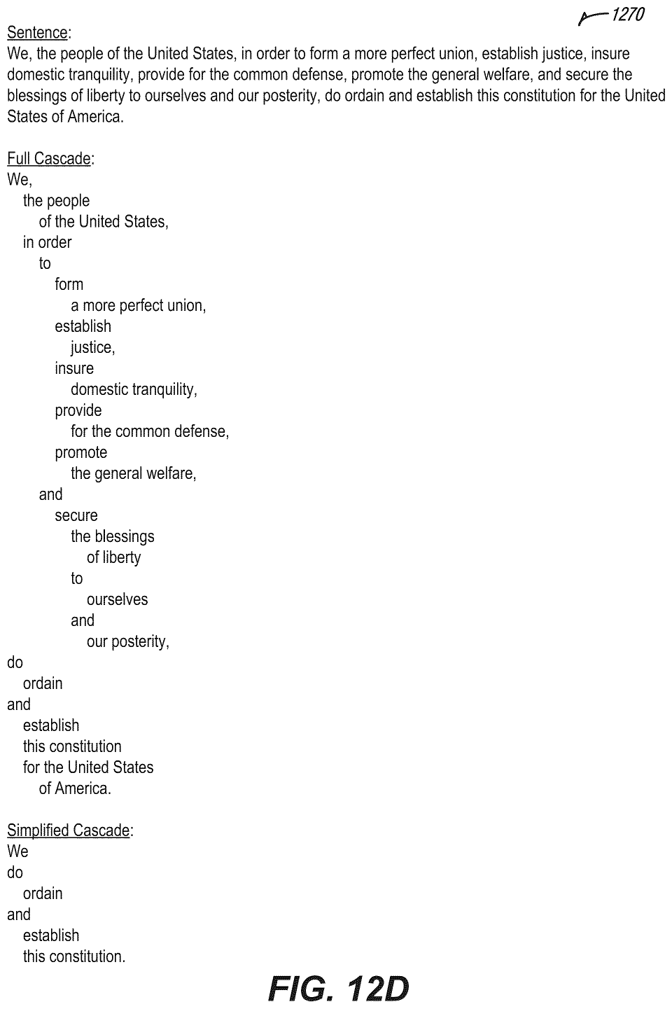

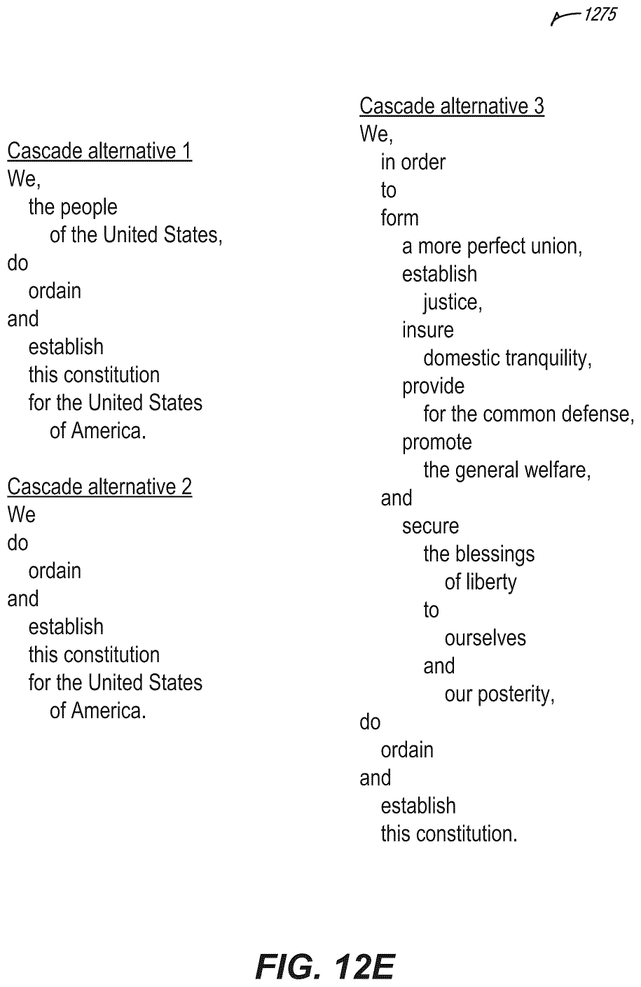

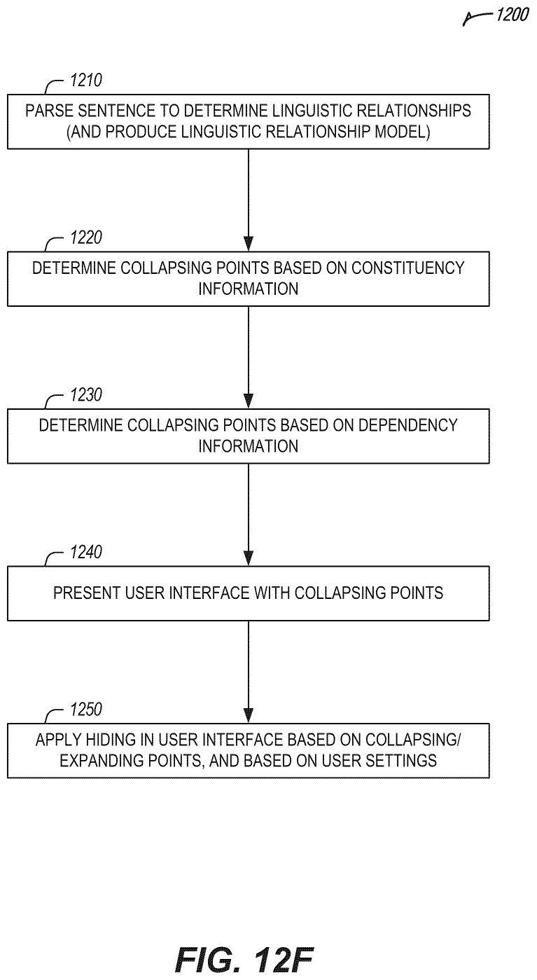

Simplifications for the purposes of summarizing content maintain the basic argument structure expressed in the sentence, so that necessary information is not lost. When a core argument is present (e.g., a direct object), these are not hidden in the simplified cascade. For example, as shown in a dependency parse 1060 of the sentence “We, the people of the United States, in order to form a more perfect union, establish justice, insure domestic tranquility, provide for the common defense, promote the general welfare, and secure the blessings of liberty to ourselves and our posterity, do ordain and establish this constitution for the United States of America.,” the basic sentence structure is “We do ordain and establish this constitution,” however all other parts of the sentence are optional modifiers describing who “we” are and what the purpose of the act is. The simplified dependency parse 1065 shown in FIG. 10F demonstrates that the basic relationships between the core elements of the simplified sentence and the original sentence remain the same as those in the dependency parse 1060 illustrated in FIGS. 10C, 10D, and 10E. Additional examples of a simplified cascade are presented in FIGS. 12A to 12E.

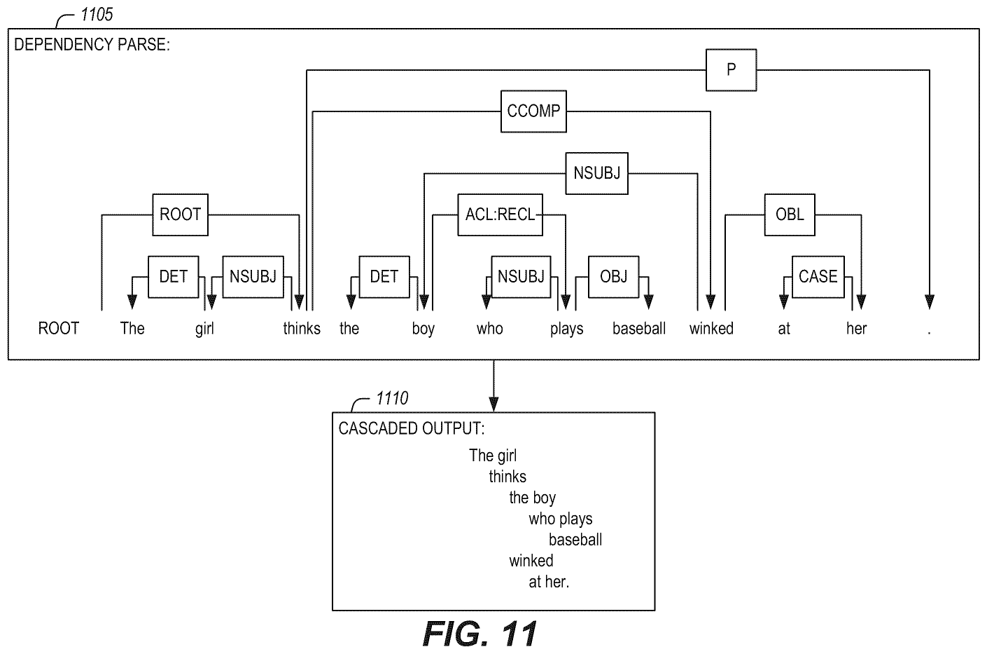

FIG. 11 illustrates a block diagram of an example of a dependency parse 1105 and cascaded text output 1110 for linguistic learning using automatically cascaded text, according to an embodiment.

Indentation rules are applied to constituents. When constituents are embedded within other constituents (e.g., relative clause, complement clauses), un-indent rules apply to signal the completion of a constituent as shown in cascade output 1110. Un-indent results in horizontal displacement being restored to the position of the head of the embedded phrase. This creates a cascade pattern that provides clear cues to the structure of the embedding and relationships between each verb vis-à-vis its head. The cascaded text output 1110 includes the indentations based on the dependency parse 1105 according to cascade rules specified in the cascade generator. Additional processing may be used to provide additional cues for cascade output displayed on devices with display limitations. For example, additional characters or other signals may be inserted to indicate that a constituent wraps to an additional line, etc.

FIGS. 12A and 12B depict example presentations of a sentence, with collapsing functionality. As shown in sentence presentations 1255 and 1260 of FIGS. 12A and 12B respectively, collapse and expand controls are presented to a user to hide portions of the cascade. Hiding may be implemented either to show the simple subject and predicate of a sentence automatically, which requires hiding all modifying phrases, or piecemeal, where particular non-core phrases are hidden based on the principles represented in the cascade rules. This could create alternative abbreviated cascades.

Collapsing may be used with an automatic option to remove all optional phrases so that a summary of the essential information in a text is created. Collapsing may also be used at demand of a user, to illustrate particular relationships within the sentence, or highlight certain pieces of information. Collapsing is only possible for parts of the sentence that hold the specific dependency relationships as described above, so the option to hide is only offered in those cases. Hence, it is not possible to hide any segment of text-only those that hold non-core linguistic relationships, as defined by the dependency parser, can be collapsed.

Simplified cascades that retain the basic meaning of the sentence are useful for summarizing content, or highlighting optional or required components of the sentence. FIG. 12C illustrates an example 1265 of a sentence with multiple non-core or modifying phrases that may be reduced into only the simple subject and predicate. For example, in a sentence “The girl with the beautiful blonde hair and outgoing personality was a favorite at school,” a prepositional phrase “with the beautiful blond hair and outgoing personality” is a noun modifier (nmod) for ‘girl’ and the prepositional phrase “at school” is a noun modifier (nmod) for ‘favorite’ (e.g., as determined by the dependency parse output and constituency parse output as shown in FIG. 10B). To simplify the sentence, these could phrases be removed so that the basic sentence ‘the girl was a favorite’ is presented.

Simplifications for the purposes of summarizing content maintain the basic argument structure expressed in the sentence, so that necessary information is not lost. As shown in the example 1270 illustrated in FIG. 12D, when a core argument is present (e.g., a direct object), these will not be hidden in the simplified cascade. For example, in the sentence “We, the people of the United States, in order to form a more perfect union, establish justice, insure domestic tranquility, provide for the common defense, promote the general welfare, and secure the blessings of liberty to ourselves and our posterity, do ordain and establish this constitution for the United States of America.,” the basic sentence structure is “We do ordain and establish this constitution,” however all other parts of the sentence are optional modifiers describing who “we” are and what the purpose of the act is. The simplified cascade shown in FIG. 12D is the most reduced version; no reductions of core arguments are possible. FIG. 12E illustrates other example cascades 1275 that may be generated for text summarization depending on a level of detail desired by a user.

FIG. 12F illustrates an example of a process 1200 for generating a folded cascaded text output, according to an embodiment. At operation 1210, a sentence is parsed to determine linguistic relationships to establish a linguistic relationship model (e.g., such as the linguistic relationship model 1015 as described in FIG. 10A). At operation 1220, collapsing points are determined based on dependency data (e.g., as output by the constituency parser 1025 and included in the linguistic relationship model 1015 as described in FIG. 10A). At operation 1230, identify a span of to-be-collapsed constituents based on a constituency parser. At operation 1240, a user interface is presented with collapsing points. At operation 1250, portions of the cascaded text are hidden in the user interface based on the collapsing points and the user settings. For example, user interface controls may be presented at collapsing points to enable the user to collapse/hide portions of the cascaded text, and to reverse the collapse/hide effects. In an example, a user interface control may be presented that, when activated, presents a simplified cascade of the text that hides text at the collapsing points. In an example, a simplified view option may be set in a user profile of the user that, when active, hides portions of the cascaded text at the collapsing points.

Core arguments are those directly licensed by the linguistic features of the specific words in a sentence. For example, an action verb has a direct object (‘obj’) relation (e.g., as determined from the dependency parse output), which defines the noun that receives the action. Such verbs are described in linguistic theory as ‘bivalent.’ A trivalent verb is one that has both a direct object (‘obj’) relation describing the thing that received the action, and also an indirect object (‘iobj’) relation describing the beneficiary of the action-as with the verb ‘give’ [a book=obj][to the library=iobj]. Valency is respected in determining which parts of a cascade may be hidden because it defines the basic argument structure of the sentence, and therefore the root message being communicated. This is consistent with the intuition that a sentence with a bivalent verb but without a direct object feels ungrammatical, or requires the comprehender to assume a direct object when one is not explicitly mentioned. For example, the sentence “Jack bought” feels incomplete, and a reader will search for background or contextual information in order to infer what was bought. Similarly, “Jack gave a dog” seems incomplete because the recipient of the dog (the indirect object) is not specified.

Core arguments are defined as constituents holding the dependency relations ‘nsubj’, ‘root’, ‘obj’, ‘iobj’, ‘csubj’, ‘ccomp’, ‘xcomp’ according to the nomenclature of the Universal Stanford Dependencies v2 (de Marneffe et al, 2014; universaldependencies.org). Other similar labeling systems that define core argument structures could also be used to achieve the same purpose, as argument structures are fundamental properties of words and do not depend on specific linguistic formalisms. These labels are also intended to be cross-linguistic, so that the current rules will apply to any language when parsed via a dependency parser using this label-set.

Reference to the Stanford Universal Dependencies (universaldependencies.org) is for convenience and ease of explanation, but the current invention does not rely solely on this presentation. The Universal Dependency initiative encapsulates the result of decades of linguistic theory defining the basic linguistic structures of a sentence; our specifications reflect the consensus in the field of linguistics (e.g., Comrie, 1993; Grimshaw, J. (1990), Argument structure, the MIT Press, in M. Aronoff, ed., Oxford Bibliographies in Linguistics, Oxford University Press, New York. (Revision) Syntax: An international handbook of contemporary research. Vol. 1. Edited by Joachim Jacobs, Arnim von Stechow, Wolfgang Sternefeld, and Theo Vennemann, 903-914; Berlin: Walter de Gruyter. Williams, Alexander. 2015. Arguments in syntax and semantics. Key Topics in Syntax. Cambridge, UK: Cambridge Univ. Press.; Levin, 2018). In addition to core arguments, the function words aux and cop, which define a verbal predicate, and the root verb (also referred to in linguistic theory as the “matrix” verb) of the sentence, cannot be reduced because the verbal element is the central element of a sentence because it determines the argument structure. Other than the core arguments and root verb, any constituent may be reduced for the purposes of presenting a simplified version of the sentence.

Non-core dependents that may be hidden are the entire constituent that holds the following relations as defined by the Stanford Universal Dependencies label-set: ‘obl’, ‘advcl’, ‘advmod’, ‘vocative’, ‘expl’, ‘dislocated’, ‘discourse’. Nominal modifiers may also be hidden; these are the entire constituent that holds the following relations: ‘nmod’, ‘appos’, ‘nummod’, ‘acl’, ‘amod’. These serve as examples, and are not an exhaustive set.

Hiding (or ‘collapsing’ or ‘reducing’) is affected at the level of the linguistic constituent, as defined by the constituency information produced by the constituency parser 1020. The entire constituent, which bears the relevant dependency relation, will be hidden on the choice of a user when so specified. Hence, the hiding operation follows the principle of Constituent Completeness: constituency delineates sets of words that function as a unit to fill a particular grammatical role (aka dependency relation) in the sentence (e.g., subject, direct object, etc.). For example, “the story was” is not a constituent because it cannot stand alone as a grammatical unit. Similarly, “the girl who” or “the” is not a constituent. Hence, when a particular relation qualifies as one that can be hidden, the entire constituent is hidden.

For example, a Dependency Parse for an entire sentence, as shown in FIG. 10C, with a modifying phrase ‘in order to form a more perfect union, establish justice, insure domestic tranquility, provide for the common defense, promote the general welfare, and secure the blessings of liberty to ourselves and our posterity’ holds the ‘acl’ relation, which is a clausal modifier. This relation is one that qualifies as being able to be hidden, and so the entire phrase is hidden when the user chooses to simplify the sentence. Similarly, “the people of the United States” holds the ‘appos’ relation, and is hidden on demand, as is ‘for the United States of America’, which holds the ‘obl’ relation.

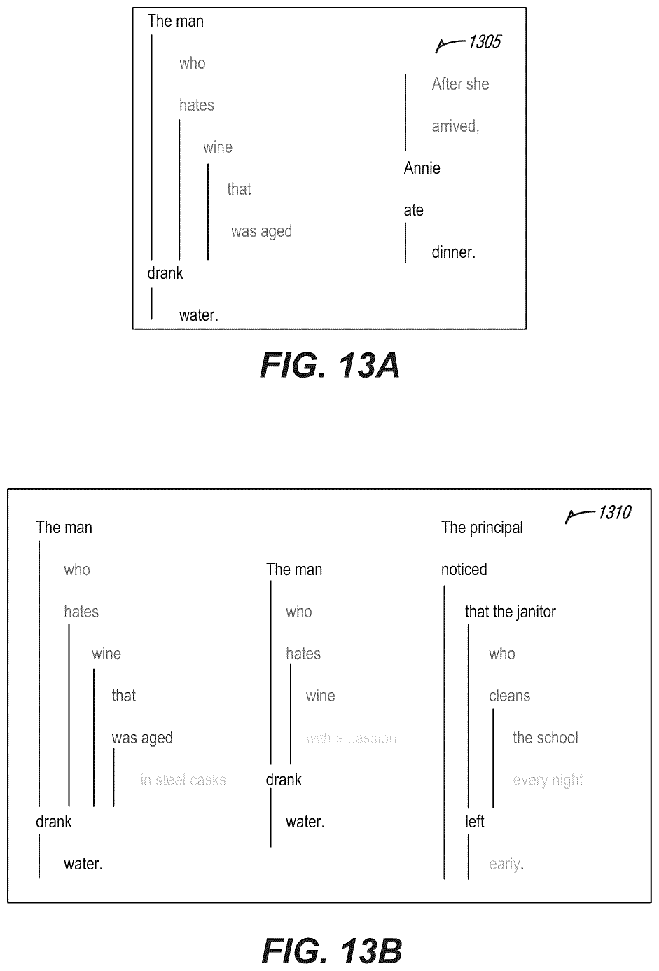

An additional method of displaying linguistic relationships and core or non-core dependency relationships is to use the underlying linguistic relationship model to colorize certain aspects of the cascade. FIGS. 13A and 13B illustrate examples of colorization 1305 and 1310 for linguistic learning using automatically cascaded text, according to an embodiment. Principles of colorization may include. (1) clauses receive a same unique color, (2) occurrence of (S, SBAR, SBARQ, SINV, SQ) signals a new color within a sentence, (3) optional elements within a clause may be a slightly lighter shade of the color of the clause, (4) matrix clause elements may be shaded with grayscale if optional unless they are clauses (e.g., advcl, parataxis, etc.), which causes them to be shaded in a color because these are clauses, etc.

The entire linguistic segment that is described by the constituency parser as SBAR (i.e., a subordinate clause) may be colored a unique color as illustrated in the examples of colorization 1305 in FIG. 13A. IN this way, each clause denotes a color scope. Because there is a separate subordinate clause (SBAR) within the first SBAR (FIG. 13A), a new color is introduced to present that embedded clause.

A basic rule for optional elements is to colorize the optional elements separately in a lighter version of the same color as their clause as shown in the examples of colorization 1310 in FIG. 13B. Optional elements are defined by dparse tags advmod, obl, nmod, obl:tmod, advcl, parataxis, and possibly others in accordance to their entry in the language relationship model. The advcl and parataxis tags require special handling because the entire clause is optional, not just the particular line on which the tag appears. The language relationship model allows the colorizing to be applied to the entire ADVCL clause, despite the fact that the tag ADVCL is only assigned to the single verb in the clause. Because the ADVCL modifier is a full clause, color is introduced rather than using greyscale shading as would be typically done for modifiers of the matrix (top-most) clause. Similar rules apply to parataxis. The ADVCL may appear in sentence initial position, in which case the entire introductory clause (SBAR) should be treated as being optional. When the ADVCL follows the main clause with the obl optional element hanging off the matrix clause and the SBAR optional element hanging off the matrix clause, the obl phrase is grey scale colored because it hangs off the matrix, but the SBAR gets its own color because it is an SBAR.

If there is an introductory subordinate clause as shown in the examples of colorization 1305, it is optional, and the introductory clause receives coloring. Modifiers that are not clauses, such as those with the relationship obl:tmod, will receive coloring in a lighter shade of the color held by the clause it is part of. If that clause happens to be the matrix (top-most) clause, then it will receive grey shading as illustrated in the examples of colorization 1310.

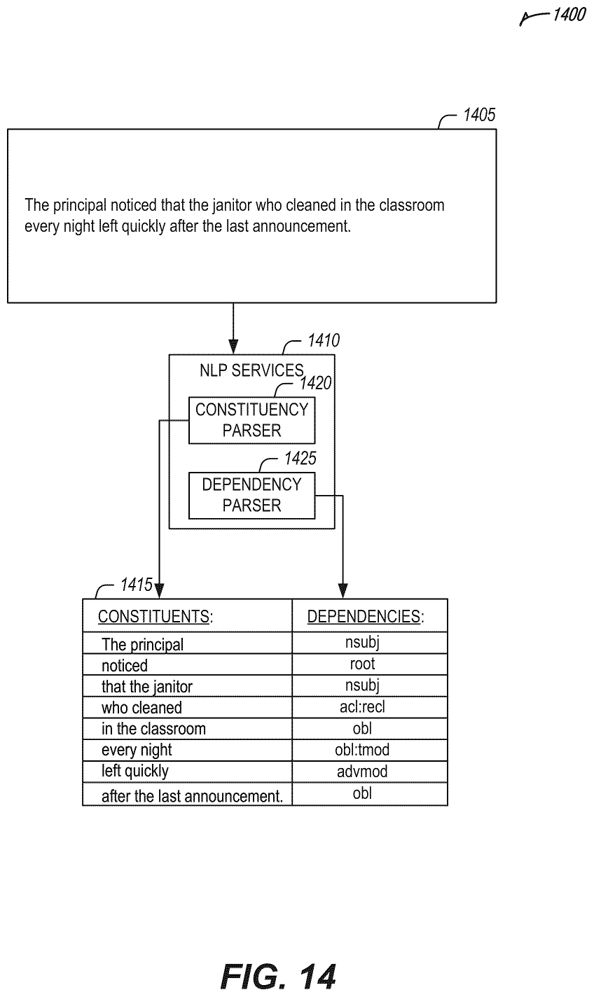

As described herein, there are provided various embodiments of systems and methods for generating cascaded text displays. In one embodiment 1400 illustrated in FIG. 14, a text portion 1405 is segmented into a plurality of dependent segments based on a linguistic relationship model generated using output from NLP services 1410. These are then combined into a language relationship model, which maps constituents onto dependency relations. Each entry in this model is a complete constituent, as defined by a constituency parser 1420, and have a dependency role as determined by a dependency parser 1425 associated with the head of the constituent. In an embodiment, constituents are identified by their maximal projection (XP) and assigned to the dependency relation associated with the head of that projection (X). For example, the constituent ‘the principal’ has two dependencies associated with it (det and nsubj), but the full constituent is assigned as an nsubj for interpretation by the cascade generator.

FIG. 15 illustrates a text portion 1505 including indentations in a cascade 1530 in accordance with a hierarchical position specified for each segment via linguistically driven automated text formatting provided by a cascade generator 1535, according to an embodiment.

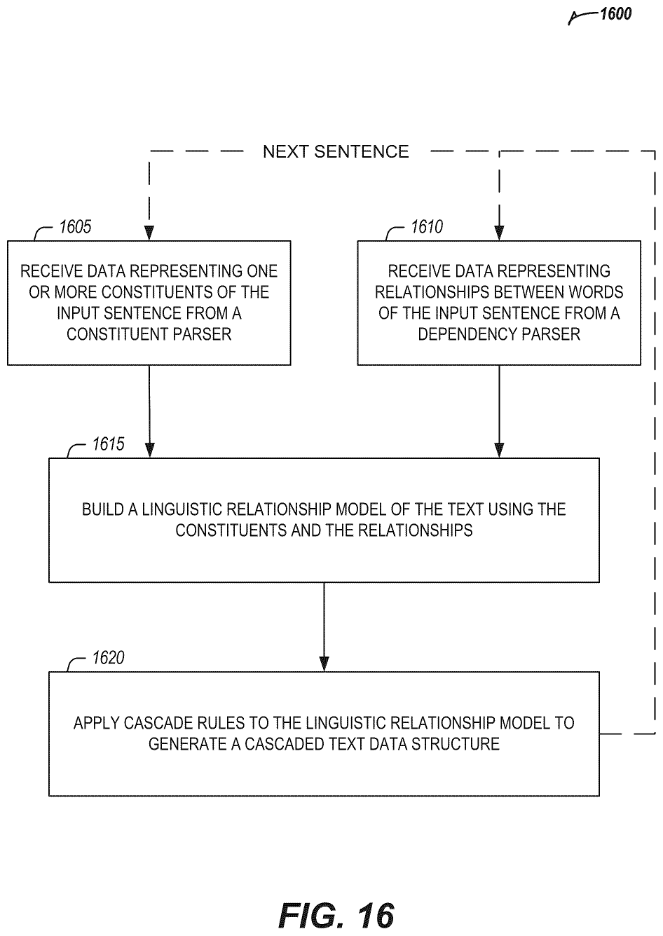

FIG. 16 illustrates an example of a method 1600 for building a linguistic relationship (text) model for linguistic learning using automatically cascaded text, according to an embodiment. The method 1600 may provide features as described in FIGS. 1 to 14.

At operation 1605, data representing one or more constituents of the input sentence may be received from a constituency parser (e.g., the constituency parser 1420 as described in FIG. 14, etc.). The data representing one or more constituents may be generated based on an evaluation of the input sentence using the constituency parser. In an example, the constituency parser may identify constituents of the sentence. In an example, a constituent may be a word or a group of words that function as a single unit within a hierarchical structure. Constituency information may also be obtained from other expert sources, including human or AI systems fully trained to identify X-bar theory constituents.

At operation 1610, data representing relationships between words of the input sentence may be received from a dependency parser (e.g., the dependency parser 1425 as described in FIG. 14, etc.). The relationships may be based on the sentence structure and may be derived based on evaluation of the input sentence using the dependency parser. In an example, a dependency may be a one-to-one correspondence so that for an element in the input sentence there is exactly one node in the structure of the input sentence that corresponds to the element. Dependency information may also be obtained from other sources, including human or AI systems fully trained to identify linguistic dependencies.

At operation 1615, a text model may be built by an input processor using the constituents and the dependency relationships (as shown in FIG. 14, etc.) In an example, the text model may be further elaborated by linguistic features produced by additional NLP-Services, including by example but not limitation, coreference information, sentiment tracking, named entity lists, topic tracking, probabilistic inference evaluation, prosodic contours, and semantic analysis.

At operation 1620, cascade rules may be applied (e.g., by the cascade generator 225 as described in FIG. 2, etc.) to the text model to generate a cascaded text data structure. In an example, the cascaded text data structure comprises text and metadata specifying display parameters for the text. In an example, the cascade text data structure comprises a file (e.g., an extensible markup language (XML) file, etc.) organized according to a schema (e.g., an XML schema, etc.). In an example, the schema comprises a specification for components and arrangement of the components in the file. In an example, the text model may be a data structure that describes constituents and dependencies of words included in the input sentence. In an example, the text model may be a data structure including a parse tree, parts of speech, tokens, constituent chart, and dependencies for the text. In an example, the cascade rules comprise formatting rules that create line breaks and indents defined corresponding to constituents and dependencies.

In an example, metadata may be generated that is associated with the cascaded text, including information required by the Cascade Explorer interface described above (e.g., parts of speech). In another example, the cascaded text comprises a set of formatted text segments including line breaks and indents for display on a display device. In some examples, the input sentence of text may be received from a source specified by a user.

In an example of a paragraph or a collection of sentences, the text may be processed before it is provided to the constituency parser or dependency parser to split text into a list of sentences. Each sentence may be processed individually (e.g., via the constituency parser 1020 and the dependency parser 1025 as described in FIG. 10A). In an example, the method 1600 is applied to each sentence in the text. For example, sentences may be displayed sequentially with each being cascaded separately, but in accordance with user preferences. In some examples, sentences may be grouped into paragraphs via visual cues other than indentation (e.g., background shading, specialized markers, etc.).

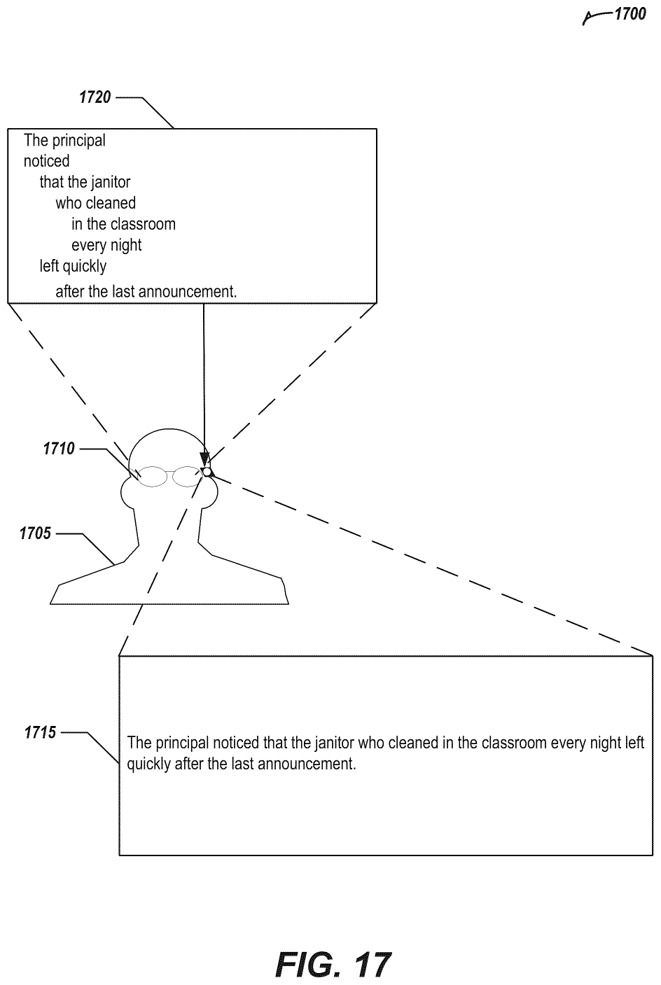

FIG. 17 illustrates an example of an environment 1700 for using an augmented reality (AR), virtual reality (VR), or mixed reality (MR) head-worn display device 1710 for linguistic learning using automatically cascaded text, according to an embodiment. The display device 1710 may present automatically cascaded text 1720 that may be generated from non-cascaded text 1715 captured by a camera in the display device 1710 or from other non-cascaded text presented in a virtual reality, augmented reality, or mixed reality environment (collectively referred to herein as “modified reality”) or provided by a secondary content source.

In an example, the display device 1710 may perform cascading functions using embedded software (e.g., executing on the device, or via a tethered or connected system) after receiving digital text via download or as direct input to a data port. In an example, display device 1710 may perform optical character recognition (OCR) using outward facing cameras that capture an image of text from a real-world object. The captured text may be converted to digital text as cascading functions are performed in real-time to produce cascaded display as output. The cascaded text may be superimposed, overlaid, or may replace the non-cascaded text captured by the cameras of the display device 1710. For example, a background of the text may be duplicated and overlaid in the modified reality environment as a canvas over the top of the non-cascaded text and the cascaded text may be displayed on the canvas. A variety of image manipulation techniques may be used to virtually erase the non-cascaded text and display the cascaded text in its place. For example, a user may view instructions on a real-world object such as a bottle and the label may be transformed to cascaded text augmenting the bottle by replacing the non-cascaded label text with cascaded label text.

In an example, the display device 1710 may be used to integrate aspects of sound or acoustic processing into a cascaded display of the modified reality environment, including for educational or instructional settings that involve spoken words or language education. The display device 1710 may present a cascade using real-time translation, such as to present a cascade in the student's first language. For example, in an educational setting used to teach a second language to a student (e.g., English as a second language, ESL), the display device 1710 may present a cascade in the student's first language that the student can comprehend visually and compare to the second language. The display device 1710 also may present a cascade based on phrases spoken by an instructor to a student, allowing the student to better understand the meaning of individual phrases when the student is practicing speaking a second language. Audio processing features of the display device 1710, such as relating to the detection or identification of spatial audio and the direction of audio from particular speakers, can also assist the presentation and emphasis of cascaded text.

Additional enhancements may be presented in a modified reality user interface to assist a student with language activities, including to identify or change prosodic cues, identify or change emphasis on particular words, identify or change pronunciation of particular words, or to track spoken words provided by the student, instructor, or a third party. Other aspects of auditory and sound processing to create or modify cascaded text may be used as described in U.S. patent application Ser. No. 18/033,243 to Van Dyke et al., published as US 2024-0257802 A1, which is incorporated by reference herein in its entirety.

In an example, the display device 1710 may enable user modification of the cascaded display in a manner that does not alter the cascade, but which adds one or more display enhancements to make the cascade it more appealing to the user (e.g., adjusting scroll speed, font, contrast, amount of text printed on the page any a given time, etc.). In an example, the cascade presentation may be modified based on inputs from device-specific hardware combined with software to use the inputs in a feedback loop. For example, the display device 1710 may include internal eye scanners to track eye movement of the user and the eye movements may be used for navigation of the cascade output and display options. Output from the eye scanners also may be evaluated to determine a specific reaction of eyes of a user to a cascade. The reaction may be correlated with other measures and modifications. For example, presentation of the cascade may be modified to support “ideal” eye tracking for reading activity, based on accumulated data of the most productive path through text as reflected in user comprehension.

In an example, as the user receives text in a block text format, the user reads multiple short passages, and eye-tracking information is gathered. The user may be presented with comprehension questions to evaluate whether the presentation assisted in reading comprehension for the user. User-specific eye movements are compared with data gathered from other readers over time to develop a cascade presentation which is optimized for the user based on data gathered including, by way of example and not limitation, user-specific eye tracking (individual and group), comprehension measures (individual and group), satisfaction/user feedback on preferences, etc.

Display enhancements and other changes in presentation for the cascaded text may include, by way of example and not limitation, changes in line spacing or indentation, means to emphasis particular words which play a key role in the sentence, using bolding, italics, color, animation, annotations, etc. These display enhancements may be coordinated with educational exercises or activities, including those being directed by a teacher or instructional aide. A personalized reading algorithm (PRA) can be created that is unique to each user based on the cascade and the specific data capture of the user from the display device 1710.

In an education context, students/teachers can see and manipulate cascades within the display device 1710 as a lesson is being delivered. For example, a teacher may teach a lesson on prepositional phrases. Each student receives passages on the device and the prepositional phrases are highlighted in the display device 1710 within the cascaded text for training purposes. Students are given new passages and are asked to identify the phrases using eye tracking or hand gestures captured by cameras in the display device 1710. In a reading assessment and diagnosis context, passages are presented and eye tracking and comprehension information is gathered from sensors in the display device 1710. The collected data is compared to larger samples to assist diagnosis of dyslexia, ADHD, and other reading challenges. Other educational use cases involving classroom or group activities, remedial instruction, testing or review, speech therapy, foreign/secondary language education, and the like may also be provided with the use of cascades presented with head-worn displays.

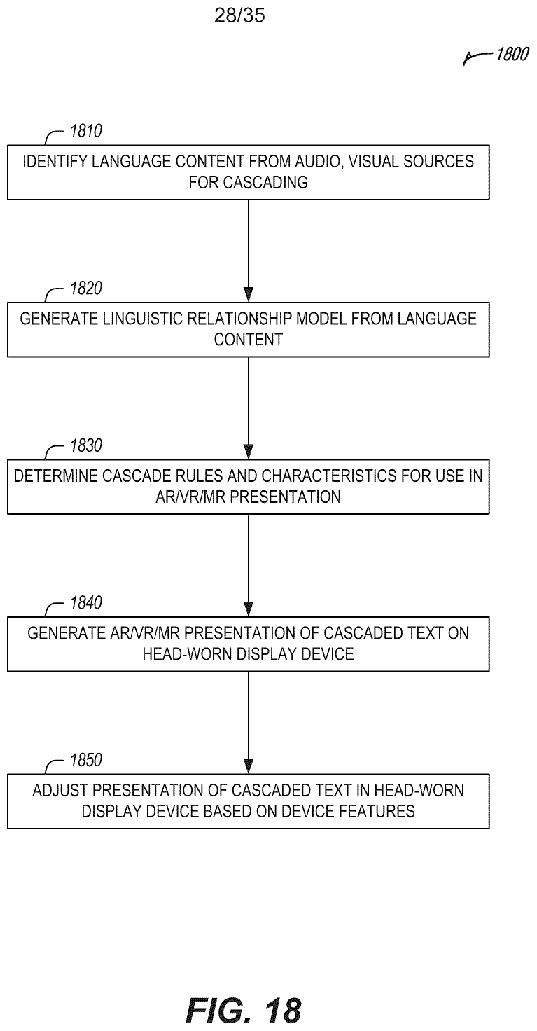

FIG. 18 illustrates an example of a process 1800 for outputting content to a head-worn display for linguistic learning using automatically cascaded text, according to an embodiment. At operation 1810, language content is identified from audio or visual sources for cascading. This may include aspects of sound (auditory) processing such as speech-to-text, or visual (image) processing such as image-to-text and optical character recognition. The language content may include individual words, phrases, sentences, or larger portions of textual content. At operation 1820, a linguistic relationship model is generated from the language content. This linguistic relationship model may be produced by the NLP service 230 as described in FIG. 2, the machine learning service 235 as described in FIG. 2, or other functions discussed above.

At operation 1830, cascade rules and characteristics are determined for specific use in a mixed reality environment, including cascade rules and characteristics (and display enhancements) that can enhance the presentation of cascaded text in specific AR, VR, or MR user interfaces and environments. These characteristics may be customized to the type or capabilities of specific head-worn display devices (such as screen size, presentation format, processing or sensor capabilities).

At operation 1840, a presentation of cascaded text is generated for use in an AR, VR, or MR presentation, to be output on the head-worn display device. The cascade rules and characteristics may be applied by the cascade generator 225, to satisfy user-specific or context-specific display settings or preferences discussed above. Finally, at operation 1850, the presentation of the cascaded text can be adjusted or modified for output in the head-worn display device. The adjustments may include any of the display enhancements discussed above, related to cascade exploration, navigation, collapsing/hiding/expanding (or folding), summarization, educational use cases, or the like.

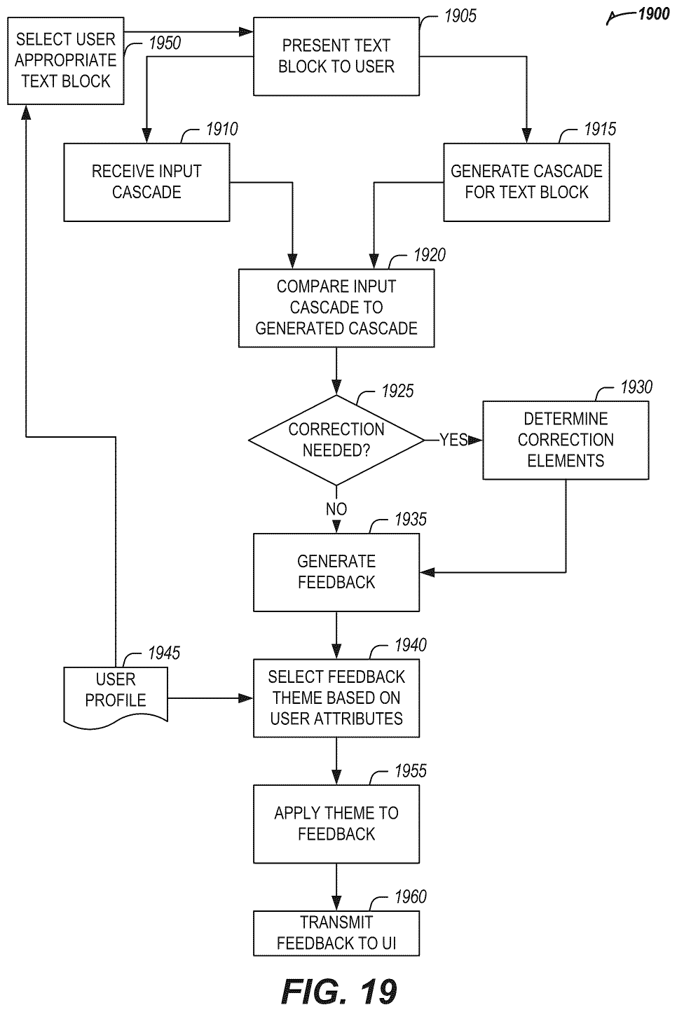

FIG. 19 illustrates a flow diagram of an example of a process 1900 for selecting content and generating feedback for an input cascade for linguistic learning using automatically cascaded text, according to an embodiment. The process 1900 may provide features as described in FIG. 1.

User profile data 1945 may be evaluated to select a user appropriate text block (e.g., at operation 1950). For example, a learning level, historical success and failure data for previously attempted learning activities, etc. may be evaluated to select a text block to present to the user. In an example, the text block may be selected based on difficulty of comprehension, a learning objective, etc. The selected text block is presented to an interactive user interface of a device used by the user (e.g., at operation 1905). In an example, the user interface may include a text output control for display of the text block. The user interface may also be presented with a text input control and text formatting controls that, when activated by the user, enable the user to format the text in a cascade format.

The input provided by the user (e.g., cascade input, etc.) may be received (e.g., at operation 1910). The text block presented to the user may be automatically cascaded by generating a language model for the text block and applying cascade rules to the language model in real-time (e.g., at operation 1915). The input cascade may be compared to the automatically generated cascade (e.g., at operation 1920). It is determined, based on the comparison, if correction is needed (e.g., if there are errors in the input cascade, etc.) (e.g., at decision 1925). If it is determined that correction is needed (e.g., at decision 1925), correction elements are identified (e.g., at operation 1930). For example, the comparison may identify cascade rules that were broken in the input cascade and may reference a map of cascade rules to linguistic concepts and the correction element may be a linguistic concept mapped to broken cascade rule in the input cascade.

Feedback is generated that may include validation if correction is not needed or may contain the correction elements if correction is needed (e.g., at operation 1935). The user profile data 1945 is referenced to select a feedback theme based on attributes in the user profile data 1945 (e.g., at operation 1940). For example, a theme for an adult or user of advance comprehension level may be primarily text-based and may include more complex wording than a theme for a younger user or with a lower comprehension level than may include simpler language and/or more image based (e.g., pictures, icons, etc.) feedback elements. The theme is applied to the feedback (e.g., at operation 1950). The correction concept, validation, and other feedback is output for display in the interactive user interface using the user appropriate theme (e.g., at operation 1955).

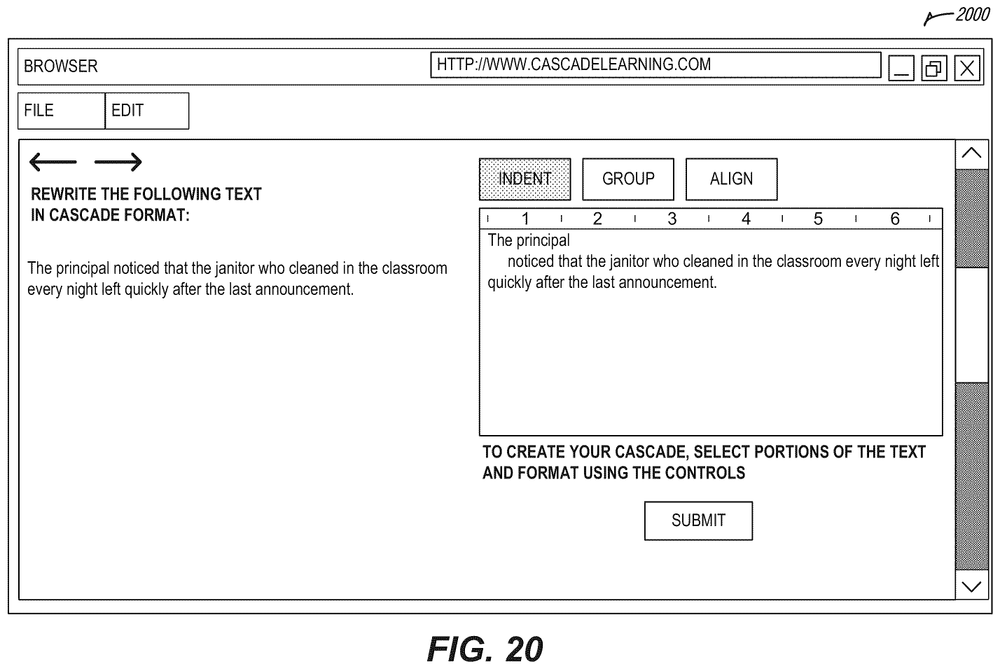

FIG. 20 illustrates an example of an interactive user interface 2000 including input and formatting controls to receive a cascade input for linguistic learning using automatically cascaded text, according to an embodiment. The interactive user interface may be generated with a block of text selected for the user based on attributes of a user profile. The user may be prompted to format the block of text to form a cascaded version of the text block using a set of formatting controls. An input box may be pre-populated with a copy of the text block, or the user may be prompted to retype the text block in the input box. The user may select one or more portions (e.g., words, phrases, etc.) of the text block and may activate a formatting control to format the selected portion. The formatting may align multiple selected portions, indent selected portions, or group selected portions. The user may then activate a submission control to submit the input cascade.

FIG. 21 illustrates an example of an interactive user interface 2100 including feedback controls to present feedback to a user based on a received cascade input for linguistic learning using automatically cascaded text, according to an embodiment. The interactive user interface 2100 is presented in response to receipt of an input cascade (e.g., as submitted via the interactive user interface 2000 as described in FIG. 20, etc.). When the input cascade is received, a machine generated cascade of a text block that was presented to a user is automatically generated and cascade rules used to generate the cascade are mapped to linguistic concepts that correspond to the cascade rules to create a cascade rule-concept map. The input cascade is compared to the machine generated cascade to identify the differences to identify cascade rules that were broken. The cascade rule-concept map is queried using the broken rules to identify the linguistic concepts that were missed by the user. The interactive user interface 2100 is generated using the machine generated cascade, the input cascade, and the missed linguistic concepts. A theme is selected and applied to the content of the interactive user interface 2100 based on attributes of the user.

In an example, feedback is presented to provide the user with information regarding the error. In an example, the feedback may include text and a hyperlink to a learning module that provides additional interactive learning for the missed concept. It should be understood that the feedback may be presented in various forms and provide a variety of modalities for reinforcing the missed linguistic concept. For example, hover controls, hyperlinks, pop-up boxes, buttons, etc. may be used to display feedback and provide a path to continue learning.

The user may be presented with a control to try to cascade another text block that, when activated, selects a new text block for the user (e.g., as described in FIG. 20). The user may also be presented with a control that may be used to continue the learning path. The missed linguistic concepts may be tracked in the profile of the user and may be used in selecting future interactive learning paths.

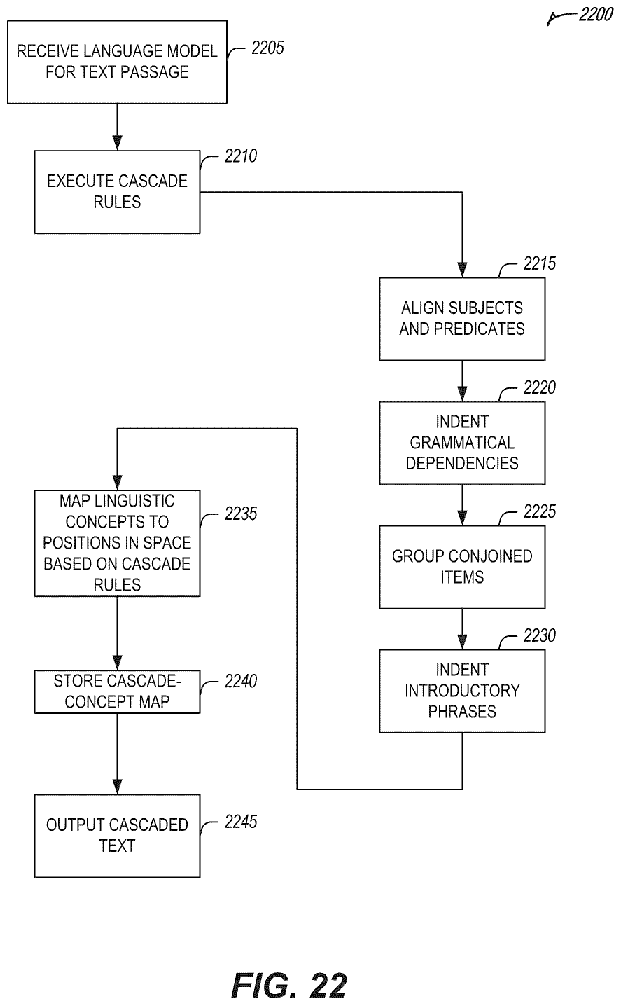

FIG. 22 illustrates a flow diagram of an example of a process 2200 for generating cascaded text and a cascade-concept map for linguistic learning using automatically cascaded text, according to an embodiment. The process 2200 may provide features as described in FIGS. 1 to 21.

A language model may be received for a text passage (e.g., at operation 2205). Cascade rules may be executed against the language model (e.g., at operation 2210). The cascade rules may include aligning subjects and predicates (e.g., at operation 2215), indenting grammatical dependencies (e.g., at operation 2220), grouping conjoined items (e.g., at operation 2225), indenting introductory phrases (e.g., at operation 2230), etc. Linguistic concepts may be mapped to positions in space based on the cascade rules (e.g., at operation 2235). A cascade-concept map generated from the mapping may be stored (e.g., at operation 2240). The machine cascaded text may be output for display (e.g., in the interactive user interface 600, etc.) (e.g., at operation 2245).

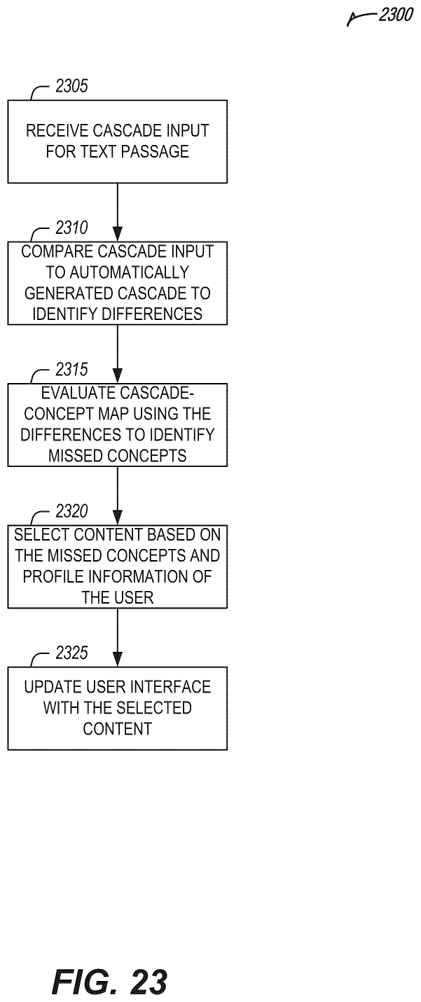

FIG. 23 illustrates a flow diagram of an example of a process 2300 for selecting feedback content based on missed concepts and profile data for linguistic learning using automatically cascaded text, according to an embodiment. The process 2300 may provide features as described in FIGS. 1 to 22.

Cascaded input may be received that was cascaded by a user (e.g., via interactive user interface 2000, etc.) (e.g., at operation 2305). The cascade input may be compared to an automatically generated cascade of a text passage presented to the user (e.g., as described in the process 2200, etc.) to identify differences (e.g., at operation 2310). A cascade-concept map (e.g., as created in the process 2200, etc.) is evaluated using the differences to identify missed concepts (e.g., at operation 2315). Feedback content is selected using the missed concepts and profile information of the user (e.g., at operation 2320). A user interface (e.g., the interactive user interface 600, etc.) is updated with the selected content (e.g., at operation 2325).

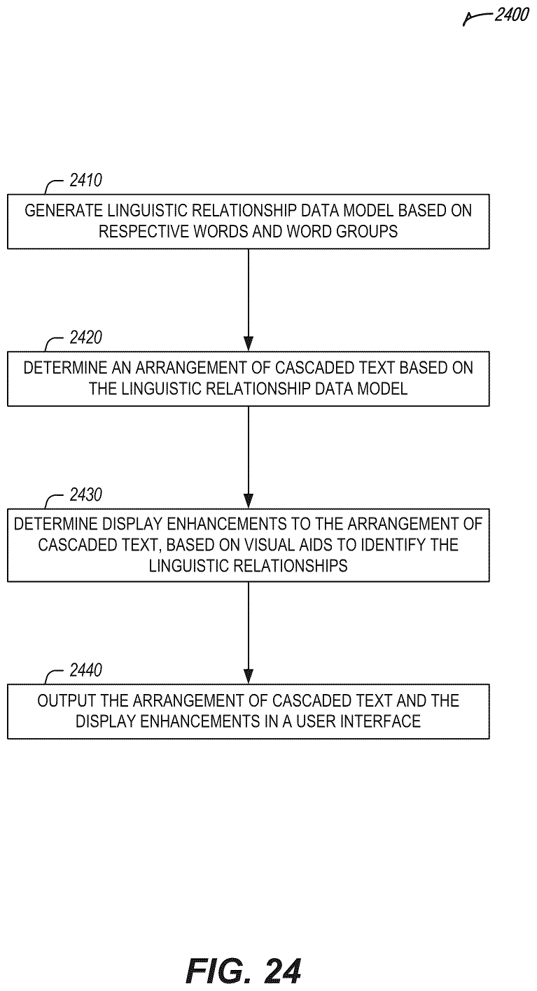

FIG. 24 illustrates a flow diagram of an example of a method 2400 for linguistic learning using automatically cascaded text, according to an embodiment. The method 2400 may be performed by system 205 or other devices or systems discussed herein.

At operation 2410, a linguistic relationship data model is generated, producing a data model that identifies linguistic relationships among respective words and word groups from a source text. This source text, in turn, may be provided directly from text sources, or from image or audio sources (e.g., image-to-text, speech-to-text).

At operation 2420, a display arrangement of the cascaded text is determined based on the data model. This display arrangement may include horizontal displacement (e.g., line spacing) and vertical displacement (e.g., indentation) for words and word groups, to produce cascaded text consistent with the examples discussed herein.

At operation 2430, display enhancements are determined, to improve the presentation of the cascaded text. These display enhancements may be based on user-selected (or user-customized) options to show visual aids for the output of the cascaded text. For example, various visual aids may directly or indirectly identify the linguistic relationships among the respective words and word groups, using annotations, highlighting, emphasis, and other display adaptation as discussed above. In an example, the display enhancements to the arrangement of cascaded text may include colorizing sections of the arrangement of cascaded text in accordance with positions of the sections indicated by the language relationships identified in the data model.

At operation 2440, the arrangement of cascaded text and the display enhancements to the cascaded text are output (or, updated as appropriate) in a user interface. This may include various display enhancements discussed above that involve the use of modified reality (e.g., AR/VR/MR) displays and devices, collapsing/expanding or summarization, highlighting and annotations, and the like.

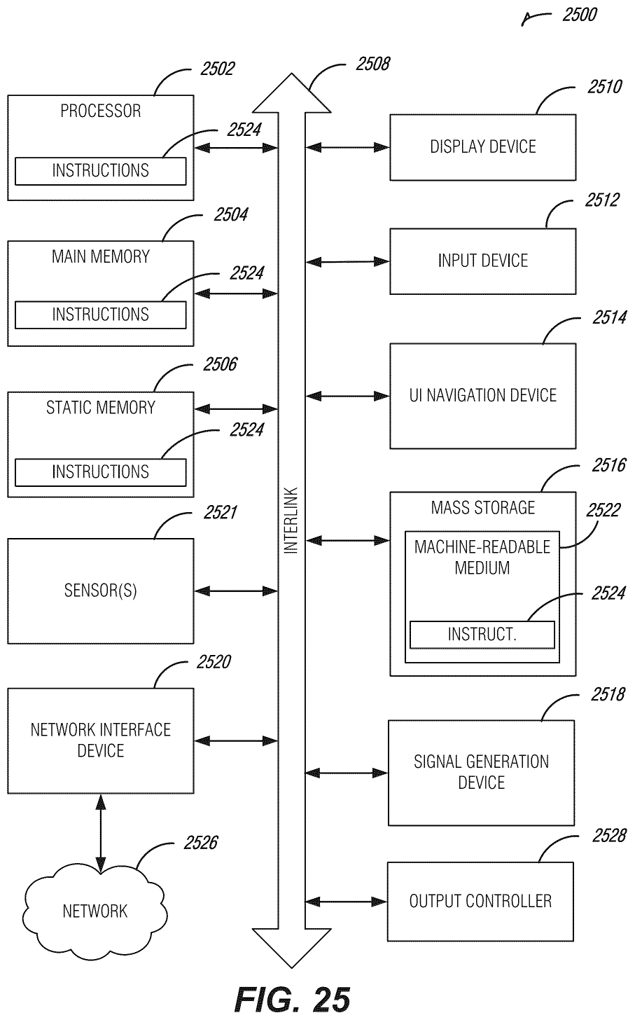

FIG. 25 illustrates a block diagram of an example machine 2500 upon which any one or more of the techniques (e.g., methodologies) discussed herein may perform. In alternative embodiments, the machine 2500 may operate as a standalone device or may be connected (e.g., networked) to other machines. In a networked deployment, the machine 2500 may operate in the capacity of a server machine, a client machine, or both in server-client network environments. In an example, the machine 2500 may act as a peer machine in peer-to-peer (P2P) (or other distributed) network environment. The machine 2500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 2500 may include a hardware processor 2502 (e.g., a central processing unit (CPU), a graphics processing unit (GPU), a hardware processor core, or any combination thereof), a main memory 2504 and a static memory 2506, some or all of which may communicate with each other via an interlink (e.g., bus) 2508. The machine 2500 may further include a display unit 2510, an alphanumeric input device 2512 (e.g., a keyboard), and a user interface (UI) navigation device 2514 (e.g., a mouse). In an example, the display unit 2510, input device 2512 and UI navigation device 2514 may be a touch screen display. The machine 2500 may additionally include a storage device (e.g., drive unit) 2516, a signal generation device 2518 (e.g., a speaker), a network interface device 2520, and one or more sensors 2521, such as a global positioning system (GPS) sensor, compass, accelerometer, or other sensors. The machine 2500 may include an output controller 2528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 2516 may include a machine readable medium 2522 on which is stored one or more sets of data structures or instructions 2524 (e.g., software) embodying or utilized by any one or more of the techniques or functions described herein. The instructions 2524 may also reside, completely or at least partially, within the main memory 2504, within static memory 2506, or within the hardware processor 2502 during execution thereof by the machine 2500. In an example, one or any combination of the hardware processor 2502, the main memory 2504, the static memory 2506, or the storage device 2516 may constitute machine readable media.

While the machine readable medium 2522 is illustrated as a single medium, the term “machine readable medium” may include a single medium or multiple media (e.g., a centralized or distributed database, and/or associated caches and servers) configured to store the one or more instructions 2524.

The term “machine readable medium” may include any medium that is capable of storing, encoding, or carrying instructions for execution by the machine 2500 and that cause the machine 2500 to perform any one or more of the techniques of the present disclosure, or that is capable of storing, encoding or carrying data structures used by or associated with such instructions. Non-limiting machine-readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 2524 may further be transmitted or received over a communications network 2526 using a transmission medium via the network interface device 2520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 2520 may include one or more physical jacks (e.g., Ethernet, coaxial, or phone jacks) or one or more antennas to connect to the communications network 2526. In an example, the network interface device 2520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 2500, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A method for presenting display enhancements to cascaded text in a user interface, comprising:
generating a data model to identify linguistic relationships among respective words and word groups in a source text;
augmenting the data model with linguistic properties associated with individual words in the source text;
determining an arrangement of cascaded text based on the linguistic relationships identified in the data model, the arrangement of cascaded text including horizontal displacement and vertical displacement for the respective words and word groups;
determining display enhancements to the arrangement of cascaded text, the display enhancements based on user-selected options to show visual aids that identify the linguistic relationships among the respective words and word groups or linguistic properties associated with individual words; and
outputting the arrangement of cascaded text and the display enhancements in a user interface.

2. The method of claim 1, wherein the display enhancements include one or more vertical alignment lines to illustrate amounts of the horizontal displacement and the vertical displacement among multiple lines of the cascaded text, and wherein the user-selected options include a setting to toggle display of the one or more vertical alignment lines.

3. The method of claim 1, wherein the display enhancements include one or more annotations to identify particular words or word groups in the cascaded text based on syntactical properties, wherein the user-selected options include a setting to toggle display of the one or more annotations onto the particular words or word groups.

4. The method of claim 3, wherein the syntactical properties correspond to one or more of: a part of speech, or a syntax group, or a relationship between groups, and wherein the one or more annotations include underlining and text labeling to identify the syntactical properties of the particular words or word groups.

5. The method of claim 1, wherein the display enhancements include color highlighting and text formatting changes to identify words in the cascaded text, wherein the color highlighting and text formatting changes are applied to a respective word of the cascaded text in response to user selection of the respective words in the user interface.

6. The method of claim 1, wherein the display enhancements include pagination applied to respective sentences, wherein respective sentences of a plurality of sentences of the source text are presented on separate pages, and wherein the user interface includes a user interface control to switch between the separate pages.

7. The method of claim 1, wherein the user interface includes a user-selectable option to switch between an exploration view and a reading view, wherein the exploration view presents the display enhancements to the arrangement of cascaded text, and wherein the reading view removes the display enhancements from the arrangement of cascaded text.

8. The method of claim 1, wherein the user interface is provided in a web browser.

9. The method of claim 8, wherein the web browser outputs the arrangement of cascaded text and the display enhancements using a plug-in, browser extension, or script.

10. The method of claim 1, wherein the display enhancements to the arrangement of cascaded text are based on use of one or more features or capabilities of a head-worn display device, and wherein the user interface enables an augmented reality, virtual reality, or mixed reality view of the arrangement of cascaded text.

11. The method of claim 1, wherein the display enhancements to the arrangement of cascaded text include summarization or collapsing of the cascaded text, and wherein the summarization or collapsing is applied to the cascaded text based on the identified linguistic relationships.

12. The method of claim 1, wherein the display enhancements to the arrangement of cascaded text include colorizing sections of the arrangement of cascaded text in accordance with positions of the sections of the arrangement indicated by the linguistic relationships identified in the data model.

13. A system for presenting display enhancements to cascaded text in a user interface, comprising:
at least one processor; and
memory comprising instructions that, when executed by the at least one processor, cause the at least one processor to perform operations to:
generate a data model to identify linguistic relationships among respective words and word groups in a source text;
augment the data model with linguistic properties associated with individual words in the source text;
determine an arrangement of cascaded text based on the linguistic relationships identified in the data model, the arrangement of cascaded text including horizontal displacement and vertical displacement for the respective words and word groups;
determine display enhancements to the arrangement of cascaded text, the display enhancements based on user-selected options to show visual aids that identify the linguistic relationships among the respective words and word groups or linguistic properties associated with individual words; and
output the arrangement of cascaded text and the display enhancements in a user interface.

14. The system of claim 13, wherein the display enhancements include one or more vertical alignment lines to illustrate amounts of the horizontal displacement and the vertical displacement among multiple lines of the cascaded text, and wherein the user-selected options include a setting to toggle display of the one or more vertical alignment lines.

15. The system of claim 13, wherein the display enhancements include one or more annotations to identify particular words or word groups in the cascaded text based on syntactical properties, wherein the user-selected options include a setting to toggle display of the one or more annotations onto the particular words or word groups.

16. The system of claim 15, wherein the syntactical properties correspond to one or more of: a part of speech, or a syntax group, or a relationship between groups, and wherein the one or more annotations include underlining and text labeling to identify the syntactical properties of the particular words or word groups.

17. The system of claim 13, wherein the display enhancements to the arrangement of cascaded text include colorizing sections of the arrangement of cascaded text in accordance with positions of the sections of the arrangement indicated by the linguistic relationships identified in the data model.

18. The system of claim 13, wherein the display enhancements include pagination applied to respective sentences, wherein respective sentences of a plurality of sentences of the source text are presented on separate pages, and wherein the user interface includes a user interface control to switch between the separate pages.

19. At least one non-transitory machine-readable medium comprising instructions for presenting display enhancements to cascaded text in a user interface that, when executed by at least one processor, cause the at least one processor to perform operations to:
generate a data model to identify linguistic relationships among respective words and word groups in a source text;
augment the data model with linguistic properties associated with individual words in the source text;
determine an arrangement of cascaded text based on the linguistic relationships identified in the data model, the arrangement of cascaded text including horizontal displacement and vertical displacement for the respective words and word groups;
determine display enhancements to the arrangement of cascaded text, the display enhancements based on user-selected options to show visual aids that identify the linguistic relationships among the respective words and word groups or linguistic properties associated with individual words; and
output the arrangement of cascaded text and the display enhancements in a user interface.

20. The at least one non-transitory machine-readable medium of claim 19, wherein the display enhancements include one or more vertical alignment lines to illustrate amounts of the horizontal displacement and the vertical displacement among multiple lines of the cascaded text, and wherein the user-selected options include a setting to toggle display of the one or more vertical alignment lines.

21. The at least one non-transitory machine-readable medium of claim 19, wherein the display enhancements include one or more annotations to identify particular words or word groups in the cascaded text based on syntactical properties, wherein the user-selected options include a setting to toggle display of the one or more annotations onto the particular words or word groups.

22. The at least one non-transitory machine-readable medium of claim 21, wherein the syntactical properties correspond to one or more of: a part of speech, or a syntax group, or a relationship between groups, and wherein the one or more annotations include underlining and text labeling to identify the syntactical properties of the particular words or word groups.

23. The at least one non-transitory machine-readable medium of claim 19, wherein the display enhancements to the arrangement of cascaded text include colorizing sections of the arrangement of cascaded text in accordance with positions of the sections of the arrangement indicated by the linguistic relationships identified in the data model.

24. The at least one non-transitory machine-readable medium of claim 19, wherein the display enhancements include pagination applied to respective sentences, wherein respective sentences of a plurality of sentences of the source text are presented on separate pages, and wherein the user interface includes a user interface control to switch between the separate pages.
